(19) United States
(12) Patent Application Publication
(10) Pub. No.: US 2008/0288391 A1
(43) Pub. Date: Nov. 20, 2008

(54) METHOD AND SYSTEM FOR AUTOMATICALLY INPUTTING, MONITORING AND TRADING SPREADS

(75) Inventors: James C. Downs, Chicago, IL (US); Leslie Rosenthal, Chicago, IL (US)

Correspondence Address: Lesavich High-Tech Law Group, P.C.;Suite 325, 39 S. LaSalle Street, Chicago, IL, 60603, US

(73) Assignee: Rosenthal Collins Group, LLC., Chicago, IL (US)

(21) Appl. No.: 12/169,738

(22) Filed: Jul. 9, 2008

Related U.S. Application Data
(63) Continuation-in-part of application No. 11/443,578, filed on May 30, 2006.
(60) Provisional application No. 60/686,079, filed on May 31, 2005.

(51) Int. Cl. G06Q 40/00

(52) U.S. Cl. 705/37

(57) ABSTRACT

A method and system for providing dynamic display of electronic trading information for trading spreads. The method and system allow spreads to be automatically inputted, executed and monitored on one or more trading exchanges. The method and system also allows inputting and monitoring of the spreads from one or more graphical windows on a graphical user interface. The method and system provide automatic generation of one or more legs of an automatic spread and automatic readjustment of desired market limit prices using one or more pre-determined spread trading factors and market depth information to maintain the desired price differential for the automatic spread.

### CROSS REFERENCES TO RELATED APPLICATIONS

This application is a Continuation-In-Part (CIP) of U.S. patent application Ser. No. 11/443,578 filed, May 30, 2006, that claims priority to U.S. Provisional Patent Application No. 60/686,079, filed May 31, 2005, the contents of all of which are incorporated by reference.

### FIELD OF THE INVENTION

This invention relates to providing electronic trading over a computer network. More specifically, it relates to a method and system for automatically inputting, monitoring and trading spreads.

### BACKGROUND OF THE INVENTION

The trading of stocks, bonds and other financial instruments over computer networks such as the Internet has become a very common activity. In many countries of the world, such stocks, bonds and other financial instruments are traded exclusively over computer networks, completely replacing prior trading systems such as “open outcry” trading in trading pits.

Trading of stocks, bonds, etc. typically requires multiple types of associated electronic information. For example, to trade stocks electronically an electronic trader typically would like to know an asking price for a stock, a current bid price for a stock, a bid quantity, an asking quantity, current information about the company the trader is trading such as profit/loss information, a current corporate forecast, current corporate earnings, etc.

The multiple types of associated electronic information have to be supplied in real-time to allow the electronic trader to make the appropriate decisions. Such electronic information is typically displayed in multiple windows on a display screen.

There are several problems with using trading strategies on electronic trading systems. One problem is that a trader will typically create his/her own trading strategies using spreads. However, most electronic trading tools known in the art do not handle trading spreads.

There have been attempts to solve some of the problems associated with electronic trading. For example, U.S. Pat. No. 7,373,327, entitled “Method and interface for presenting last traded quantity information,” that issued to Kemp, et al., “Trading software may receive trading information from an exchange. The trading software may use the trading information to compute an estimate of last traded total sweep quantity. The trading software may also display the last traded total sweep quantity on a trading screen.”

U.S. Pat. No. 7,366,691, entitled “Method and interface for presenting last traded quantity information,” that issued to Kemp, II, et al., “Trading software may receive trading information from an exchange. The trading software may use the trading information to compute an estimate of last traded total sweep quantity. The trading software may also display the last traded total sweep quantity on a trading screen.”

U.S. Pat. No. 7,348,981, entitled “Graphical display with integrated recent period zoom and historical period context data,” that issued to Buck, “A system and method are provided for displaying a data series. In one embodiment, a graphical interface is provided including at least one axis that is divided into a plurality of axis regions. Preferably, each axis region uses a different linear scale, and the plurality of axis regions forms a continuous non-linear scale. The graphical interface also displays the data series in relation to the plurality of axis regions, and the data series is plotted in relation to each axis region based on a scale resolution corresponding to each respective axis region.”

U.S. Pat. No. 7,243,083, entitled “Electronic spread trading tool,” that issued to Burns, et al., “A versatile and efficient electronic spread trading tool to be used when buying and selling comparable commodities either simultaneously or in conjunction with one another. The spread trading tool involves a method of displaying, on an electronic display device, the market depth of a plurality of commodities including an anchor commodity and a non-anchor commodity, where the method includes dynamically displaying a plurality of bids and asks in the market for the commodities, statically displaying prices corresponding to those plurality of bids and asks, where the bids and asks are displayed in alignment with the prices corresponding thereto, displaying an anchor visual indicator corresponding to and in alignment with a desired price level of the anchor commodity, displaying a price level indicator corresponding to and in alignment with a price level of the non-anchor commodity. Based on an unhedged position, and taking into account the parameters and spread price point values, as determined by the trader, price level indicators are calculated and displayed, which provide a visual representation of where the trader should buy and sell the applicable commodities. The price level for the price level indicator in the non-anchor commodity is determined based upon said desired price level of the anchor commodity. The price level indicator also includes a first visual indicator corresponding to and in alignment with a first price level of the non-anchor commodity and a second visual indicator corresponding to and in alignment with a second price level of the non-anchor commodity.”

U.S. Pat. No. 7,228,289, entitled “System and method for trading and displaying market information in an electronic trading environment,” that issued to Brumfield, et al., “A system and method for trading and displaying market information along a static axis are described to ensure fast and accurate execution of trades. The static axis, whether is a straight axis or a curved one, can be oriented in any direction. Regardless of how the axis is oriented, a first region may display price levels that are arranged along the static axis. A second region, which overlaps the first region, may display one or more indicators for highlighting one of the price levels associated with the lowest offer and one of the price levels associated with the highest bid. Moreover, a third region, which overlaps the first region, may be included for initiating placement of an order to buy or an order to sell the tradeable object through an action of a user input device. Other overlapping regions may also be displayed so that additional market information may be viewed by a trader.”

U.S. Pat. No. 7,218,325, entitled “Graphical display with integrated recent period zoom and historical period context data,” that issued to Buck, “A system and method are provided for displaying a data series. In one embodiment, a graphical interface is provided including at least one axis that is divided into a plurality of axis regions. Preferably, each axis region uses a different linear scale, and the plurality of axis regions forms a continuous non-linear scale. The graphical interface also displays the data series in relation to the plurality of axis regions, and the data series is plotted in relation to each axis region based on a scale resolution corresponding to each respective axis region.”

U.S. Pat. No. 7,212,999, entitled “User interface for an electronic trading system,” that issued to Friesen, et al. “A user interface for an electronic trading exchange is provided which allows a remote trader to view in real time bid orders, offer orders, and trades for an item, and optionally one or more sources of contextual data. Individual traders place orders on remote client terminals, and this information is routed to a transaction server. The transaction server receives order information from the remote terminals, matches a bid for an item to an offer for an item responsive to the bid corresponding with the offer, and communicates outstanding bid and offer information, and additional information (such as trades and contextual data) back to the client terminals. Each client terminal displays all of the outstanding bids and offers for an item, allowing the trader to view trends in orders for an item. A priority view is provided in which orders are displayed as tokens at locations corresponding to the values of the orders. The size of the tokens reflects the quantity of the orders. An alternate view positions order icons at a location which reflects the value and quantity of the order. Additionally, contextual data for the item is also displayed to allow the trader to consider as much information as possible while making transaction decisions. A pit panel view is also provided in which traders connected to the pit are represented by icons, and are displayed corresponding to an activity level of the trader.”

U.S. Pat. No. 7,127,424, entitled “Click based trading with intuitive grid display of market depth and price consolidation,” that issued to Kemp, II, et al., “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuate. This allows the trader to trade quickly and efficiently. The price consolidation feature of the present invention, as described herein, enables a trader to consolidate a number of prices in order to condense the display. Such action allows a trader to view a greater range of prices and a greater number of orders in the market at any given time. By consolidating prices, and therefore orders, a trader reduces the risk of a favorable order scrolling from the screen prior to filling a bid or ask on that order at a favorable price.”

U.S. Pat. No. 7,124,110, entitled “Method and apparatus for message flow and transaction queue management,” that issued to Kemp, II, et al., “Management of transaction message flow utilizing a transaction message queue. The system and method are for use in financial transaction messaging systems. The system is designed to enable an administrator to monitor, distribute, control and receive alerts on the use and status of limited network and exchange resources. Users are grouped in a hierarchical manner, preferably including user level and group level, as well as possible additional levels such as account, tradable object, membership, and gateway levels. The message thresholds may be specified for each level to ensure that transmission of a given transaction does not exceed the number of messages permitted for the user, group, account, etc.”

U.S. Pat. No. 7,113,924, entitled “System and method for electronic spread trading in real and synthetically generated markets,” that issued to Fishbain, “A system and method are provided to analyze synthetic and real markets that offer interchangeable tradeable objects to find market opportunities that a trader may capitalize on. A synthetic market is an electronic market created out of real markets by a computer terminal or gateway. A real market is an electronic market that is offered by an electronic exchange. If a desirable market opportunity is found, the preferred embodiments can take action such as by sending orders to either one of the markets, or by sending orders to both markets. An advantage of the preferred embodiments, among many others, is that they can make “invisible” trading opportunities more readily apparent.”

U.S. Pat. No. 6,993,504 entitled “User interface for semi-fungible trading,” that issued to Frisen et al. teaches “A user interface and method are disclosed for providing trading between a plurality of semi-fungible and non-fungible goods. A plurality of book axes are displayed in a single interface, each book axis representing a market for a particular good. Orders for goods are displayed as marks on the axes to display the relative value of the orders. A value axis is provided that relates the value of the goods from each market to each other. Thus, a single interface provides the means to relate the values of different semi-fungible goods. The value axis may be displayed in units of price, or a custom value designated by a user or pre-defined by the interface. Quantity information is represented in the interface through the display of a dimension of an order icon. Precise information about each order is displayed either in a panel view or a pop-up window.”

U.S. Pat. No. 6,938,011 entitled “Click based trading with market depth display,” that issued to Kemp et al. teaches “A method and system for reducing the time it takes for a trader to place a trade when electronically trading commodities on an exchange, thus increasing the likelihood that the trader will have orders filled at desirable prices and quantities. Click based trading, as described herein and specifically the “Click” and “Dime” methods of the present invention, enables a trader to execute single mouse click trades for large volumes of commodities at a price within a pre-specified range.”

U.S. Pat. No. 6,772,132 entitled “Click based trading with intuitive grid display of market depth,” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,766,304 entitled “Click based trading with intuitive grid display of market depth,” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,408,282 entitled “System and method for conducting securities transactions over a computer network,” that issued to Buist teaches “The system and method of the preferred embodiment supports trading of securities over the Internet both on national exchanges and outside the national exchanges. The preferred embodiment supports an improved human interface and a continuous display of real-time stock quotes on the user's computer screen. The ergonomic graphical user interface (GUI) of the preferred embodiment includes several functional benefits in comparison with existing on-line consumer trading systems. In the preferred embodiment, the users are subscribers to a securities trading service offered over the Internet. Preferably, each subscriber to this service is simultaneously connected from his own computer to a first system which provides user-to-user trading capabilities and to a second system which is a broker/dealer system of his/her choice. The system providing the user-to-user trading services preferably includes a root server and a hierarchical network of replicated servers supporting replicated databases. The user-to-user system provides real-time continuously updated stock information and facilitates user-to-user trades that have been approved by the broker/dealer systems with which it interacts. Users of the preferred system can trade securities with other users of the system. As part of this user-to-user trading, a user can accept a buy or sell offer at the terms offered or he can initiate a counteroffer and negotiate a trade.”

U.S. Pat. No. 5,297,031 entitled “Method and apparatus for order management by market brokers,” that issued to Gutterman et al. teaches “There is provided a broker workstation for managing orders in a market for trading commodities, securities, securities options, futures contracts and futures options and other items including: a device for selectively displaying order information; a computer for receiving the orders and for controlling the displaying device; and a device for entering the orders into the computer; wherein the displaying device comprises a device for displaying selected order information about each incoming order, a device for displaying a representation of an order deck and a device for displaying a total of market orders. In another aspect of the invention, there is provided in a workstation having a computer, a device for entering order information into the computer and a device for displaying the order information entered, a method for managing orders in a market for trading commodities, securities, securities options, futures contracts and futures options and the like comprising the steps of: selectively displaying order information incoming to the workstation; accepting or rejecting orders corresponding to the incoming order information displayed; displaying accepted order information in a representation of a broker deck; and selectively displaying a total of orders at the market price.”

Thus, it is desirable to solve some of the problems associated with implementing trading strategies using spreads on electronic trading systems.

### SUMMARY OF THE INVENTION

In accordance with preferred embodiments of the present invention, some of the problems associated trading spreads are overcome. A method and system for automatically inputting, monitoring and trading spreads.

The method and system allow spreads to be automatically inputted, executed and monitored on one or more trading exchanges. The method and system also allows inputting and monitoring of the spreads from one or more graphical windows on a graphical user interface. The method and system provide automatic generation of one or more legs of an automatic spread and automatic readjustment of desired market limit prices using one or more pre-determined spread trading factors.

The foregoing and other features and advantages of preferred embodiments of the present invention is more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic trading system;

FIG. 2 is a block diagram illustrating an exemplary electronic trading display system;

FIG. 3 is a flow diagram illustrating a method for displaying electronic information for electronic trading;

FIG. 4 is a block diagram of a screen shot of an exemplary tools window;

FIG. 5 is a block diagram of a screen shot of an exemplary settings window;

FIG. 6 is a block diagram of a screen shot of an exemplary quotes and contracts window;

FIG. 7 is a block diagram of a screen shot of an exemplary order window;

FIG. 8 is a block diagram of a screen shot of an exemplary fill window;

FIG. 9 is a block diagram of a screen shot of an exemplary position and market data window;

FIG. 10 is a block diagram of a screen shot of an exemplary position and market data window for an order ticket from a sell position;

FIG. 11 is a block diagram of a screen shot of an exemplary position and market data window for a stop order;

FIG. 12 is a block diagram of a screen shot of an exemplary ABV window;

FIG. 13 is a block diagram of screen shot of an exemplary order ticket window;

FIG. 14 is a block diagram of a screen shot of an exemplary reports window;

FIG. 15 is a flow diagram illustrating a method for automatically trading spreads;

FIG. 16 is a block diagram of a screen shot of an exemplary ABV window illustrating a spread selection window; and

FIG. 17 is a flow diagram illustrating a method for automatically executing trading spreads;

FIG. 18 is a block diagram illustrating plural specialized graphical windows displayed from a specialized spread application;

FIG. 19 is a flow diagram illustrating a method for automatically executing trading spreads;

FIG. 20 is a block diagram illustrating a screen shot of an exemplary spread definition window;

FIG. 21 is a block diagram illustrating a screen shoot of an exemplary contracts window display automatic spread information;

FIG. 22 is a block diagram illustrating a screen shot of an exemplary ABV window displaying automatic spread information and including market depth information;

FIG. 23 is a flow diagram illustrating a method for automatically executing trading spreads;

FIG. 24 is a flow diagram illustrating a method for automatically executing trading spreads;

FIG. 25 is a block diagram illustrating exemplary ABV windows illustrating a lean parameter for an exemplary automatic spread.

### DETAILED DESCRIPTION OF THE INVENTION

### Exemplary Electronic Trading System

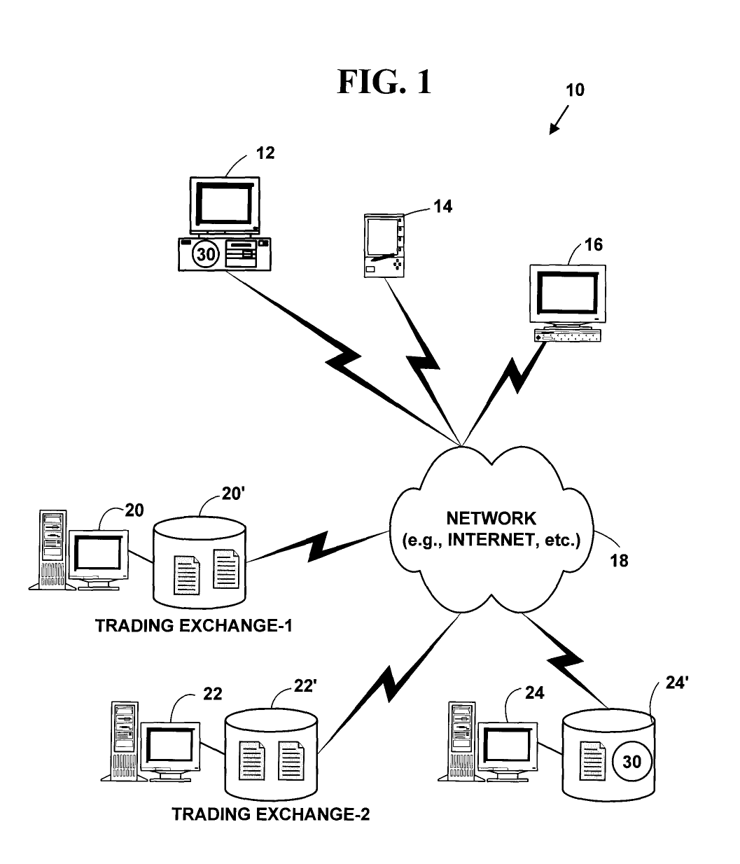

FIG. 1 is a block diagram illustrating an exemplary electronic trading system 10. The exemplary electronic information updating system 10 includes, but is not limited to, one or more target devices 12, 14, 16 (only three of which are illustrated). However, the present invention is not limited to these target electronic devices and more, fewer or others types of target electronic devices can also be used.

The target devices 12, 14, 16 are in communications with a communications network 18. The communications includes, but is not limited to, communications over a wire connected to the target network devices, wireless communications, and other types of communications using one or more communications and/or networking protocols.

Plural server devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural server devices 20, 22, 24 include, but are not limited to, servers used for electronic trading exchanges, servers for electronic trading brokers, servers for electronic trading information providers, etc.

The one or more target devices 12, 14, 16 may be replaced with other types of devices including, but not limited to, client terminals in communications with one or more servers, or with personal digital/data assistants (PDA), laptop computers, mobile computers, Internet appliances, two-way pagers, mobile phones, or other similar desktop, mobile or hand-held electronic devices. Other or equivalent devices can also be used to practice the invention.

The communications network 18 includes, but is not limited to, the Internet, an intranet, a wired Local Area Network (LAN), a wireless LAN (WiLAN), a Wide Area Network (WAN), a Metropolitan Area Network (MAN), a Public Switched Telephone Network (PSTN) and other types of communications networks 18.

The communications network 18 may include one or more gateways, routers, bridges, switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments. Switches typically operate at the data link layer and sometimes the network layer therefore support virtually any packet protocol.

The communications network 18 may include one or more servers and one or more web-sites accessible by users to send and receive information useable by the one or more computers 12. The one or more servers, may also include one or more associated databases for storing electronic information.

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

### Exemplary Electronic Trading Display System

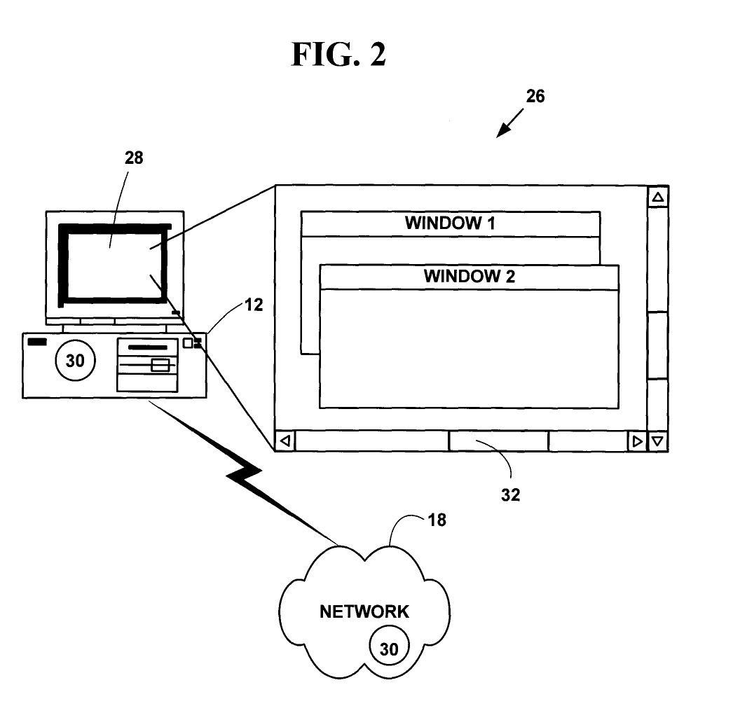

FIG. 2 is a block diagram illustrating an exemplary electronic trading display system 26. The exemplary electronic trading system display system includes, but is not limited to a target device (e.g., 12) with a display 28. The target device includes an application 30 that presents a graphical user interface (GUI) 32 on the display 28. The GUI 32 presents a multi-window interface to a user.

In one embodiment of the invention, the application 30 is a software application. However, the present invention is not limited to this embodiment and the application 30 can firmware, hardware or a combination thereof.

An operating environment for the devices of the electronic trading system 10 and electronic trading display system 26 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It is appreciated that acts and symbolically represented operations or instructions include the manipulation of electrical signals by the CPU or processor. An electrical system represents data bits which cause a resulting transformation or reduction of the electrical signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Exemplary Method for Processing Electronic Information for Electronic Trading

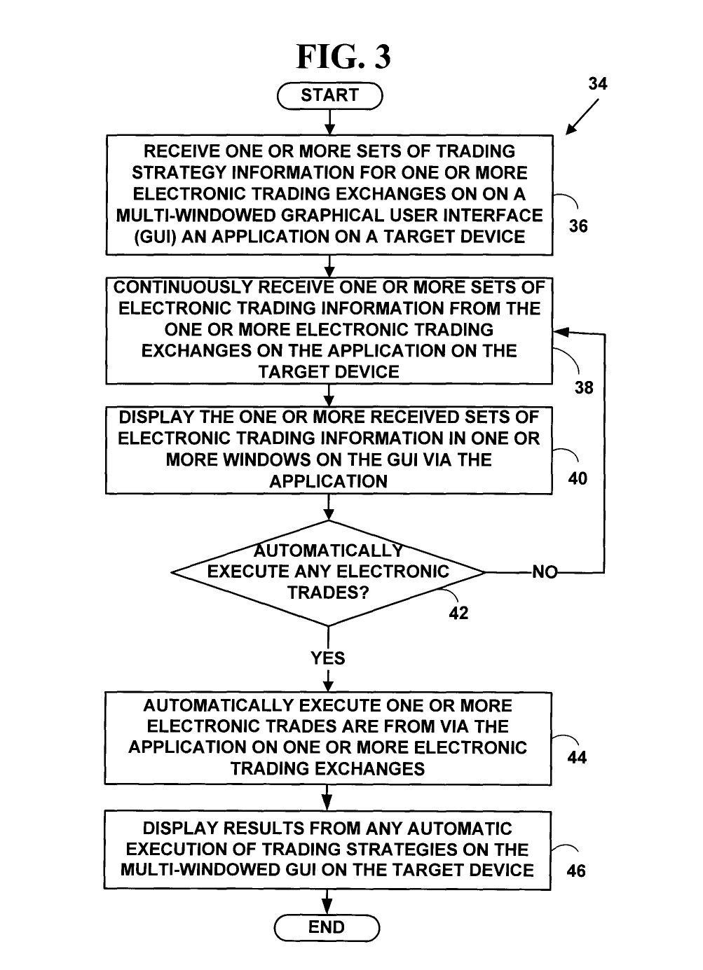

FIG. 3 is a flow diagram illustrating a Method 34 for processing electronic information for electronic trading. At Step 36, one or more sets of electronic trading strategy information is obtained via one or more windows on a application 30 on a target device 12, 14, 16 to automatically execute one or more electronic trades on one or more electronic trading exchanges 20, 22. At Step 38, one or more sets of electronic trading information are continuously received on the application 30 via one or more application program interfaces (API), fixed or dynamic connections from one or more electronic trading exchanges 20, 22. At Step 40, the one or more sets of electronic trading information are displayed in one or more windows on the GUI 32 via application 30. At Step 42, a test is conducted to determine if any electronic trades should be automatically executed based on the one or more sets of electronic trading strategy information. If any electronic trades should be automatically executed, at Step 44, one or more electronic trades are automatically electronically executed via application 30 an appropriate electronic trading exchange 20, 22. At Step 45, results from any automatic execution of any electronic trade are formatted and displayed in one more windows on a multi-windowed graphical user interface (GUI) 32.

In one embodiment the one or more sets of electronic trading strategy includes a pre-determined trading strategy created by a trader, if-then trading strategies, one-cancels-other (OCO) trading strategies and electronic trading strategies for synthetic instruments or synthetic contracts, or execution of strategies based on previously executed orders.

As is known in the art, the pre-determined strategy trading strategy is a pre-determined trading strategy developed by a trader to apply to a desired market (e.g., cash, futures, stocks, bonds, options, spreads etc.)

As is known in the art, a “synthetic” instrument or contract includes an instrument or contract that does not really exist on any electronic trading exchange. A synthetic can be made up of one, or several contracts that trade on an exchange or multiple exchanges. For example, a synthetic contract may include automatically selling a call and buying a put. Such a synthetic contract does not exist on any trading exchange but is desirable to a selected group of traders.

As is known in the art, an API is set of routines used by an application program to direct the performance of actions by a target device. In the present invention, the application 30 is interfaced to one or more API.

In another embodiment, the application 30 is directly interfaced to a fixed or dynamic connection to one or more electronic trading exchanges without using an API.

In one exemplary embodiment of the invention, the application 30 interfaces with a Client API provided by Professional Automated Trading Systems (PATS) of London, England, or Trading Technologies, Inc. (TT) of Chicago, Ill. GL Multi-media of Paris, France and others. These APIs are intermediate APIs between the Application and other APIs provided by electronic trading exchanges. However, the present invention is not limited to such an embodiment and other APIs and other fixed or dynamic connections can also be used to practice the invention.

The application 30 presents a user a multi-windowed GUI 32 that implements the functionality exposed through API provided by electronic trading exchanges. The application 30 allows the user to subscribe to and receive real-time market data. Additionally, the application 30 allows the user to enter futures orders, cash orders, and other types of financial products orders to all supported exchanges and receive real-time order status updates. The application 30 supports at least two methods of order entry; Order Ticket and Aggregated Book View and/or Ask Bid Volume (ABV).

The application 30 provides flexibility to the user to configure the display of electronic information on the GUI 32. The application 30 and the GUI are now described in further detail.

### Desktop Layout Management

The application 30 provides the ability to manage Desktop Layouts. A Desktop Layout is a state of a GUI 32 as it appears to a user. This includes, but is not limited to, number of windows, types of windows, and the individual window settings. A user is able maintain a list of available Desktop Layouts. Each Desktop Layout has a unique name within the application 30. The user is able to create a new Desktop Layout and save it, giving it a unique name. When the user saves a Desktop Layout, it is not saved in a minimized state but is instead saved in an expanded state. The user is able to rename, copy, and delete a Desktop Layout. The user is able to load a saved desktop layout, replacing the currently displayed configuration. The application 30 receives and loads desktop layout templates from the communications network 18 upon user login. The user is able to export and import desktop layouts in order to port them from target device to target device. Desktop Layouts are saved on a user by user basis (e.g., by username). If two users access the application 30 from the same target device 12, each user sees their own list of layouts upon login.

The application 30 is launched from target device 12, 14, 16 or via the network 18 (e.g., the Internet, an intranet, etc.) The application 30 is installed on a target device 12, 14, 16 or the communications network 18. Upon startup, the application 30 detects if a new version is available. If the application 30 detects that an upgrade is warranted, a window appears, asking the user if they would like to install the latest version now. In one embodiment, if the user chooses not to install the latest version upon startup, the current (older) version of the application 30 is launched. In another embodiment, another prompt is displayed when the user logs off. In the case of a critical update, the user is not able to choose to run the application 30 without installing the update.

The application 30 is pushed information that determines which servers the application 30 is to connect to. IP addresses or Domain Name Servers (DNS) names are pushed to the client when upon login.

In one embodiment, the application 30 can be used by up to about 5,000 simultaneous users. Scalability allows the application 30 to be used by up to about 20,000 simultaneous users. However, the present invention is not limited to such an embodiment and other embodiments with other numbers of simultaneous users can also be used to practice the invention.

The application 30 indicates the status of a host connection 20, 22, 24 on the communications network 18. As a minimum, “Connecting,” “Connected” and “Not Connected” statuses are indicated. The application 30 indicates the status of an electronic trading exchange server connection 20, 22. As a minimum, “Connecting,” “Connected” and “Not Connected” statuses are indicated for the electronic trading exchange server connection.

If settings (e.g., accounts, contracts, etc.) change on a host system 20, 22, 24, the application 30 updates the settings. The user does not have to log back in to see the changes. The application 30 has the ability to detect if any changes to accounts or contracts have been made. The application 30 is able to detect when a system administrator has changed a network address (e.g., an Internet Protocol (IP) address, etc.) of the primary transaction server for a client.

The application 30 can log off of one network address and log onto another. Data integrity is maintained when a network address change has been made. The application 30 notifies the user of any working orders or open positions before closing. The user has the opportunity to cancel the logout if they would like to cancel working orders or close the open positions. The application 30 performs the normal logoff cycle when closed by the user. The application 30 saves all data needed to return it to the state it was in when the application 30 was closed. The application 30 saves all data necessary to restore it to the current state in the case of a catastrophic application 30 failure. If the user does not choose to download the most recent version of the application 30 upon startup, a message appears upon logoff asking the user if they would like to install the upgrade before closing.

In one embodiment, application 30 gracefully log users out at an end of day. The user receives a warning message, stating that the session is about to be closed. The user needs to log back in to reestablish the connection. The application 30 allows the user to combine the display of data of different types. Data types include, but are not limited to, Orders, Fills, Positions and Market Data. The application 30 supports the functionality exposed through the current version of a client API. In another embodiment, the application 30 does not log users out at an end of a day.

The application 30 supports data format differences between exchanges that are not normalized by the client API. The application 30 supports differences between exchange order handling semantics that are not normalized by the client API. The application 30 gracefully handles spreads. The application 30 support systems with multiple monitors. All exchange contracts supported by a platform are considered by the application 30. Online user documentation is available to the user. The application 30 runs on Windows 2000, Windows XP operating systems and other windowed operating systems (e.g., Linux, etc.). The application 30 architecture is flexible in order to allow additional functionality to be added when needed.

### Standard Windows Grid

In a Standard Windows Grid, a user can select from a list of columns to display. The user is able to add or remove columns, but all columns may not be able to be removed and certain columns may need to be added in order to add other columns (if there are dependencies). Each window will have certain columns that appear in the grid by default. The grid has a column heading with a caption (column name).

The user can change an order of the displayed columns by dragging the column heading to a new position. The user can manually resize a column. The user can resize all columns to fit the screen. The user can resize all columns to fit their contents. The user can resize a selected column to fit the column's contents. This is accomplished by double clicking on the column heading's right border. The user can change the foreground and background colors of a column. The user can rename any grid column. The user can restore the default grid column names. The user can restore all default grid settings.

The user can change the font for all columns in the grid. This includes, but is not limited to font type, color and size. The user can change the font for an individual column. This includes, but is not limited to, font type, color and size. The user can sort the data in the grid by clicking on a column heading. The user can sort the data in ascending or descending order. The user can create multiple sort criteria. The user can create a filtered view of the information in a grid. The user can filter on multiple criteria for non-numeric columns. Filters can include more then one column. Multiple filters for numeric columns can be created (e.g., for an =, ≠, <, >, ≦ or ≧ operation, etc.). This functionality also allows the user to choose a range. The user can remove filters from a grid. Data in a grid will continue to be updated while a filter is applied.

### Login Window

A Login window will be launched via the application 30 when the application 30 is first accessed by the user. A user will enter a user name and password in order to log into the application 30. A successful login will allow the user full access to multi-windowed GUI 32 functionality. A failed login displays a message to the user, indicating that either the user name or password were invalid, but not which one. If Caps Lock is on, the failed login message the application 30 indicates this fact. The failed login message reminds the user about case sensitivity. The user is able to change passwords. The user does not have to be logged into the communications network 18 to change passwords.

The application 30 updates a database with the new password. All characters entered into a password field will be visible to the user as asterisks. A single login allows the user access to all supported and enabled exchanges.

### Application Manager Window

An Application Manager Window allows the user to access all of the functionality of the application 30. It is via these windows that other application windows are launched and managed. The GUI 32 windows are automatically launched once the user has successfully logged in. Only one Application Manager window is launched by the application 30.

The Application Manager Window, by default, is a member of every display layout on the GUI 32 and cannot be removed. The user is able to view a list of available Desktop Layouts and select one to work with.

The user can create a new Tools window, Settings window, Contact and Quotes Window, Orders and/or Fills window, Positions/Market Data window, Aggregated Book View window, Order Ticket window and Reports window from the Application Manager Window. The user can also open a saved window from the Application Manager Window.

The user can maintain Desktop Layouts from the Application Manager Window. The user can minimize all windows and restore all windows from the Application Manager Window.

### Client Messaging Window

A Client Message Window allows the user to view system messages, trading exchange messages and alerts. This window is automatically launched once the user has successfully logged in. In one embodiment, only one Client Messaging window may be launched by the application 30. In another embodiment, more than one Client Message windows may be launched by the application 30. The Message display, by default, is a member of every display layout and cannot be removed. Users who are logged on must be able to receive system messages, communications from office personnel, electronic trading exchange messages and alerts from various electronic trading exchanges 20, 22.

Alert receipts are displayed for the user. The window displays the entry and cancellation of orders (as messages). Alerts are given a priority, including, but not limited to, of “Critical,” “High,” “Medium” or “Low.”

Alerts of a high priority are presented in a more intrusive manner than lower priority alerts. Upon login, users receive alerts from the current day that were sent while they were logged off. The user is able to turn off the display of alerts and are able to turn off the display of messages.

### Tools Window

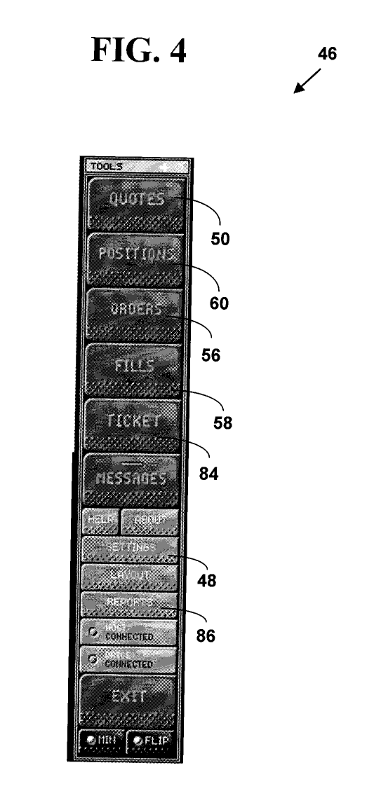

FIG. 4 is a block diagram of screen shot of an exemplary Tools window 46 produced by application 30 and displayed on the GUI 32. The Tools window 46 is used to launch other windows described herein on the GUI 32.

### Settings Window

FIG. 4 is a block diagram of screen shot of an exemplary Settings window 48 produced by application 30 and displayed on the GUI 32. The Settings window 48 allows the user to enter application-wide settings (such as defaults, etc.) This window 48 is accessible via the Manager window. The window 48 is different from any other window in the application. Multiple Settings windows cannot be opened, and this window is not part of a Desktop Layout.

The Settings window 48 displays network address (e.g., local and Internet IP addresses) of a target device 12, 14, 16. The Setting window 48 displays the Host and Price server IP addresses and ports that are being used by the application 30.

In one embodiment, the user loads settings from a settings file via the Settings window 48. The settings file contains information necessary to replicate the configuration of an application, including settings and desktop layouts. For audible alerts, each alert should have a different sound. The user can browse for sound files to assign to events. In another embodiment, settings are loaded from automatically from data structure within the application 30.

The user can turn on or off audible and/or visual alerts for the events listed below in Table 1. However, the present invention is not limited to these audible and/or visual alert events and more, fewer or other types of audible and/or visual alert events can be used to practice the invention.

TABLE 1

Logout
Login
Receipt of a fill
Entry of an order
Entry of an order amend
Entry of a cancel request
Receipt of an order
Receipt of a cancel
Receipt of an amend
Receipt of a reject
Receipt of a message
Order state timeouts
Loss of connection to the host server
Loss of connection to the price server
Reconnection to the host server
Reconnection to the price server
Receipt of SARA alerts
A different sound/visual alert is used for each priority level.
Limit breach
Contract breach
Exchange disabled
Stop price triggered for synthetic stops and stop limit orders
Pull all orders
End of day/End of market
By exchange
This information is downloaded on login if an update is needed.
Custom Reminders
OCO fill
OCO cancel
Parked order violated
If Then fill
If Then cancel
P/L bracket fill
P/L bracket cancel

The user can set the following defaults for an order ticket listed in Table 2. However, the present invention is not limited to these defaults and more, fewer or other types of defaults can be used to practice the invention.

```
TABLE 2
Default Account
Default Exchanges and Contracts
Default Order Type
  The user can set the default order type by exchange or to set the same default
  for all exchanges.
Default side
Default Quantity
  The user can set the default quantity by instrument or to set the same default for
  all instruments.
Close after order entry
  The user can determine whether or not the Order Ticket should close by default
  after an order has been entered.
Quantity set to zero after order entry
  The user can determine whether or not the order quantity should return to zero
  once an order has been placed.
Default price for limit orders - Sell
  The user can determine whether the price for sell limit orders should default to
  current bid, ask, or last.
Default price for limit orders - Buy
  The user can determine whether the price for buy limit orders should default to
  current bid, ask, or last.
Other Settings
Always on Top
  The user can set which window should stay on top by default (if any).
  This default may be overridden on a window by window basis.
Order State Timeouts
  The user can set the amount of time that an order can remain in a state of Sent,
  Queued, Cancel Pending or Amend Pending before an order state timeout alert
  is generated.
Custom Reminders
  The user can create and maintain a list of custom reminders, which will create an
  audible and visual alert at the set date and time.
  The user can assign a title, date, time and description to each reminder.
  Custom reminders are saved on the local machine.
ABV Market Depth
  The user can set the amount of market depth displayed on the ABV window.
  A Market Depth setting greater than the maximum depth disseminated by the
  exchange will be treated as the exchange maximum.
Hot Keys
  The user can assign program shortcuts to keyboard function keys.
Fonts
  The user can set a default font for all text on all windows.
  The user can restore all fonts to the font selected here (after changes have been
  made on individual windows).
Key Pad (for Quantity)
  The user can assign the values for keypad buttons.
  These values will be displayed on the key.
Order Quantity Limits (Fat Finger Rules)
  The user can set the maximum quantity that may be entered for an order.
  An order exceeding this limit will not be entered.
Commissions
  The user can enter commission amounts by exchange and/or by instrument.
  The commissions set here are used in the user's P&L calculations.
Print Reports
  The user can choose whether or not a window should appear upon logoff, asking
  if reports should be printed.
  From the window (if displayed), the user should be able to specify which reports
  are printed.
```

### Contracts and Quotes Window

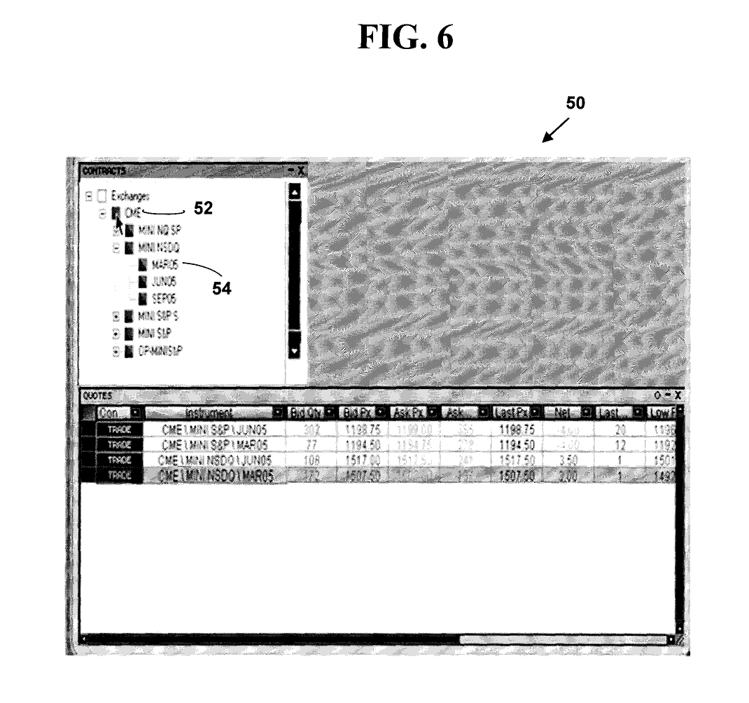

FIG. 6 is a block diagram of screen shot of an exemplary Quotes and Contracts window 50 produced by application 30 and displayed on the GUI 32. The user can select which exchange 52 (e.g., Chicago Mercantile Exchange (CME), Chicago Board of Trade (CBOT), New York Stock Exchange, etc.) and which instruments, contract and contract date combinations (e.g., Mini NSDQ March 2005) to display 54. Market data associated with a position by the unique instrument information is also displayed.

### Order and Fills Windows

The user is able to display any combination of order and fill information that they choose (although some information must be displayed in order for other information to be displayed) in Order and Fill windows respectively. The user is provided with an Orders template and a Fills template, which will each display different default data (and, therefore, provide different functionality based on user defined preferences set via the Settings window 48).

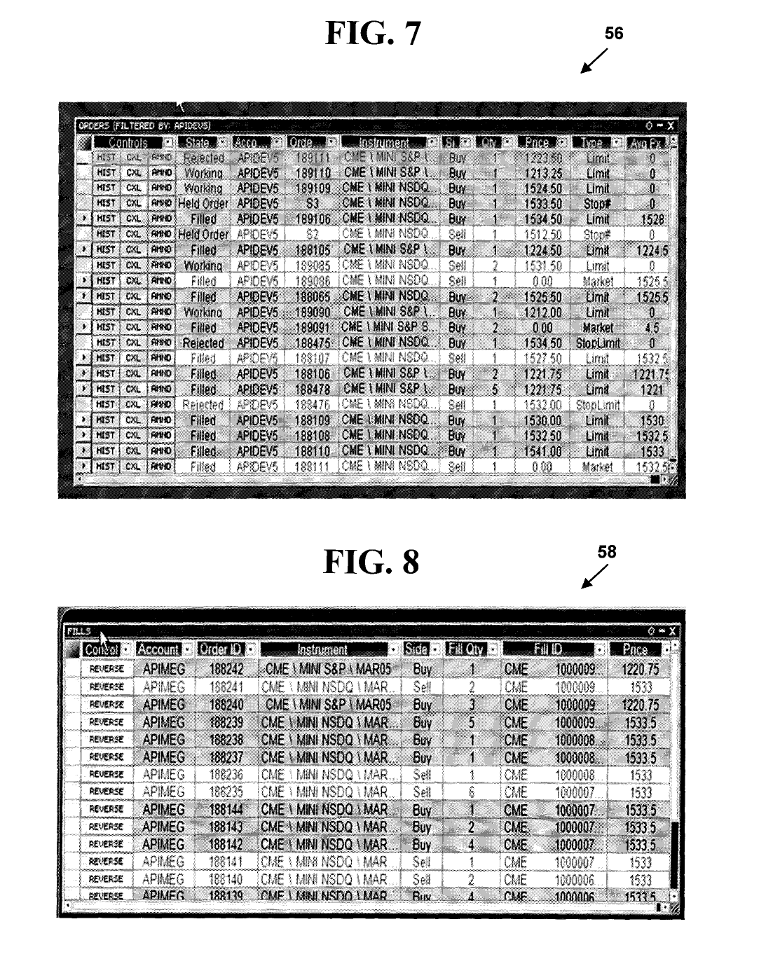

FIG. 7 is a block diagram of screen shot of an exemplary Order window 56 produced by application 30 displayed on GUI 32. Typically, an order is created by the user and submitted to an electronic trading exchange 20, 22 for possible execution. One exception to this is the Parked order. In this case, the application 30 saves the order until it is released by the user to the electronic trading exchange 20, 22.

In one embodiment, the Order window 56 displays, but is not limited to, a controls identifier, a state identifier (e.g., rejected, working, filled, held) an account identifier (e.g., APIDEV5), an order number, an instrument identifier (e.g., CME\MINI S&P), a side designation identifier (e.g., buy or sell), a quantity, a price, a type identifier (e.g., limit, pre-defined stop price, market price) an average price. However, the present invention is not limited to displaying these items and more, fewer or other items can be displayed in the Order window 56 to practice the invention.

FIG. 8 is a block diagram of screen shot of an exemplary Fills window 58 produced by application 30 displayed on GUI 32. Typically, a fill is an acknowledgment from an electronic trading exchange 20, 22 where the order was submitted that all or part of the order was executed. A special case is an external fill. An external fill is submitted manually by a system administrator.

In one embodiment, the Fills window 58 displays, but is not limited to, a control identifier, an order identifier, an instrument identifier, a side identifier, a fill quantity, a fill identifier and a fill price. However, the present invention is not limited to displaying these items and more, fewer or other items can be displayed in the Fills window 58 to practice the invention.

A new or saved Order and Fill windows 56, 58 can be launched from the Application Manager window. When the user creates and submits an order to an electronic trading exchange 20, 22, an order with a quantity greater then the maximum order limit will be rejected by the application 30. The user can create a trailing stop order against a filled order. The user is also able to create a Profit/Loss bracket around a filled order.

The user can also create a “Parked” order. A Parked order is an order that is created by the user but not submitted to an electronic trading exchange 20, 22. Parked orders are saved by the application 30 and made available to the user between application 30 launches. The user can change a working order to a parked order and visa versa. Changing a working order to a parked order, the application 30 sends a cancel to the selected electronic trading exchange 20, 22. On receipt of the cancel acknowledgement, the application 30 will change the order state to indicate that the order is parked.

The user can also submit a Parked order to an electronic trading exchange 30. The user can submit all parked orders at once. The user can select certain parked orders to submit (at once). The user can change the electronic trading exchange and/or contract for a parked order. If the user changes the contract, the application 30 will verify that the entered price is valid for the new contract. If the entered price is invalid for the new contract, the application 30 will prompt the user to change the price. The user can change the account for a parked order.

The user can cancel a working order. In one embodiment, a working order can be canceled with a single mouse click. In another embodiment a working order can be canceled with two mouse click, one to cancel the order and one to confirm cancellation. The user can cancel all working orders in a selected account, cancel all working buy orders in the selected account, all working sell orders in the selected account.

The user can delete a parked order. The use can delete a parked order with a single mouse click. The user can delete all parked orders in a selected account. The user can delete all parked orders in all accounts.

The user can change the following order information (for a working order) illustrated in Table 3. However, the present invention is not limited to this order information and more, fewer or other types of order information can be used to practice the invention.

```
TABLE 3
Prices (stop/limit/stop limit)
Quantity
  The user must be able to display the detailed order history for an order
  (both parked orders and those submitted to an exchange.
The order history includes orders that led to the current order if the order
was created by a cancel/replace or a parked order.
```

The user can also create a trailing stop order against a fill. The user can create a Profit/Loss bracket around a fill. The user can launch an Order Ticket window from a specific fill. When an Order Ticket is opened from a fill, the ticket is pre-populated with the data that corresponds to that fill (e.g., exchange, instrument, quantity, etc.)/The side of the Order Ticket will be opposite that of the fill. Supported order types will be available to be created from the Order Ticket. Trailing stops and brackets can be linked to another order, such as a limit order. When this order is executed the Trailing Stop or bracket, etc. is then submitted to the market, or held “working” on the target device 12, 14, 16.

The Fills window 58 displays a detailed view of a fill. A fill detail includes all available fill information (including partial fills). The application 30 handles external fills. The application 30 uses separate display indicators if the fill is external (e.g., color difference, etc) on the GUI 32.

In one embodiment, Order and Fill information is displayed following standard window rules laid out by the Standard Window. The data in this Order and Fill window is displayed in the standard grid format, as described in the Standard Grid. This window will display order and fill data. The user chooses which fields should be displayed in the grid (some fields will appear by default) on the GUI 32.

Table 4 illustrates a list of order information that used in the Order and Fill windows 56, 58. Most of the information is exposed through the APIs used. However, in a few cases the information is calculated. These exceptions are indicated where they occur. However, the present invention is not limited to this order information and more, fewer or other types of order information can be used to practice the invention.

```
TABLE 4
Order ID
Display ID
Exchange Order ID
User Name
Trader Account
Order Type
Exchange Name
Contract Name
Contract Date
Buy or Sell
Price
Price2
Lots
Linked Order
Amount Filled
Number of Fills
Amount Open
  This field is calculated by the application 30 using contract lots
  minus amount filled.
Average Price
  This field (the average price of all fills that make up an order) is
calculated by the application 30 because the API does not return
the correct value if there is only one lot.
Status
Date Sent
Time Sent
Date Host Received
    This field will not displayed to the user, but is used for logging.
Time Host Received
    This field will not be displayed to the user, but is used for logging
Date Exchange Received
    This field will not be displayed to the user, but is used for logging.
Time Exchange Received
Date Exchange Acknowledged
Time Exchange Acknowledged
Non Execution Reason
Good-Till-Date
```

Table 5 illustrates a list of fill information that used in the Order and Fill windows 56, 58. Most of the information is exposed through the APIs used. However, in a few cases the information is calculated. These exceptions are indicated where they occur. However, the present invention is not limited to fill information and more, fewer or other types of fill information can be used to practice the invention.

```
TABLE 5
Display ID
Exchange Order ID
User Name
Trader Account
Order Type
Exchange Name
Contract Name
Contract Date
Buy or Sell
Lots
Price
Average Price
    This field will need to be calculated by the application because
    the API does not return the correct value if there is only one lot.
Date Filled
Time Filled
Date Host Received
    This field will never be displayed to the user, but is used for logging.
Time Host Received
    This field will never be displayed to the user, but is used for logging
Fill Type
Fill, External, Netted, Retained
```

### Positions/Market Data Window

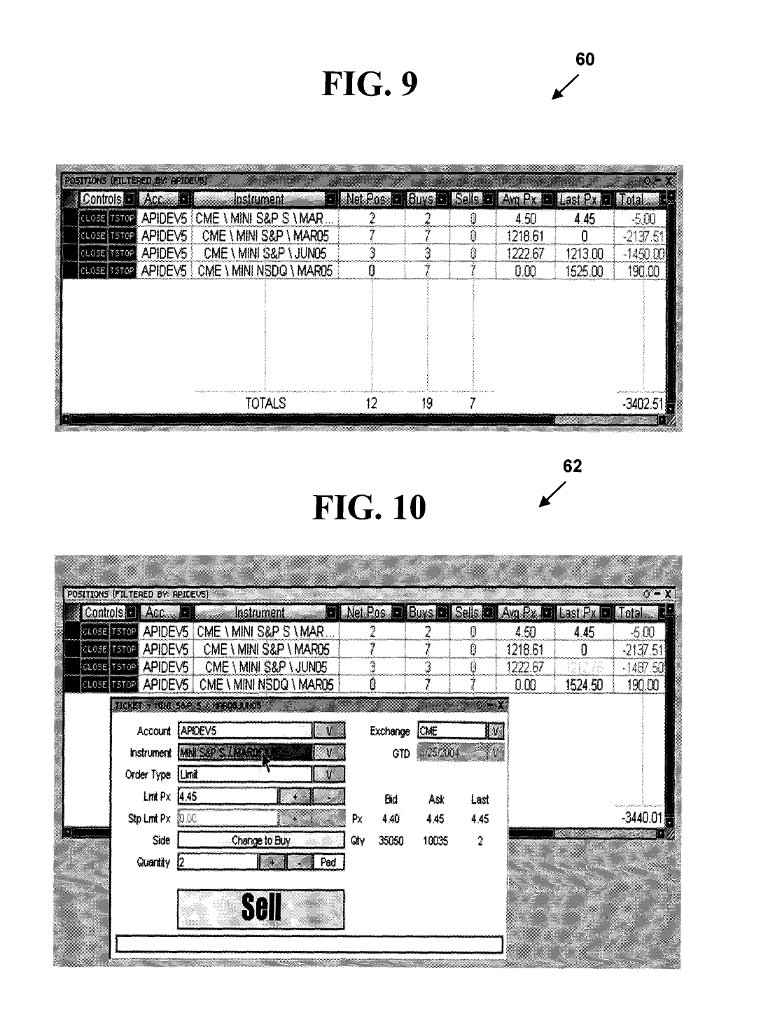

FIG. 9 is a block diagram of screen shot of an exemplary GUI 32 Position and Market Data window 60 produced by application 30 displayed on the GUI 32. The Positions and Market Data Window 60 provides representation and display of open positions and market data in the application 30.

In one embodiment, the Positions and Market Data window 60 includes, but is not limited to a display of a controls identifier, an account identifier, a net position, a number of buys, a number of sells, an average price, an last price and a total. However, the present invention is not limited to displaying these items and more, fewer or other items can be displayed in the Position and Market Data window 58 to practice the invention.

The user can display any combination of order and fill information that they choose (although some information must be displayed in order for other information to be displayed). The user is provided with an Orders template and a Fills template, which will each display different default data (and, therefore, functionality).

An “open position” is a long, short, or profit or loss in an instrument or contract in an account. This open position is the aggregation of all the fills received in the instrument. Market data is delivered to the application 30 in real-time through the APIs used. A new or saved Positions/Market window 60 can be launched from the Application Manager window. The user can launch an Order Ticket window 84 from a specific position.

FIG. 10 is a block diagram of screen shot of an exemplary Position and Market Data window for an Order Ticket from a sell position 62 produced by application 30 and displayed on the GUI 32. When a ticket is opened from a position, an Order Ticket window 84 is pre-populated with the data that corresponds to that position (e.g., exchange, instrument, quantity, etc.). For example in FIG. 10, an Order Ticket window includes data (e.g., APIDEV5, CME\MINI S&P, Limit, Limit Px 4.45, Quantity 2, etc.). The side of the Order Ticket will be opposite that of the position. The user can launch a window that will allow them to create a Profit/Loss (P/L) Bracket around an open position. The order sides default to opposite of the position. The order quantities default to the position quantity. The user can also launch a window that will allow them to create a Stop or Stop Limit order against an open position.

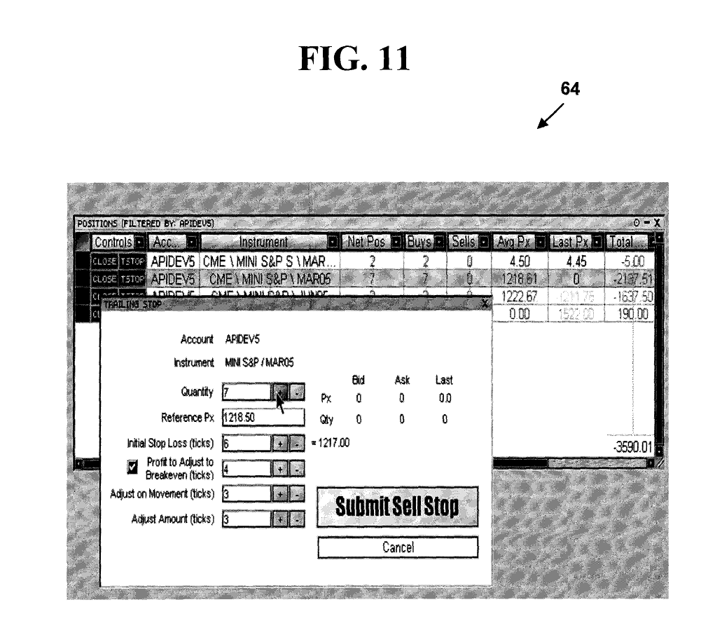

FIG. 11 is a block diagram of screen shot of an exemplary Position and Market Data window for a sell stop order 64 produced by application 30 displayed on the GUI 32. The order side defaults to opposite of the position. The order quantity defaults to the position quantity. The user can also launch a window that will allow them to create a Limit order against an open position. The order side defaults to opposite of the position. The order quantity defaults to the position quantity.

The user can display all of the fills that comprise a position. The user can flatten the open position in the instrument for the selected account. The window 60 includes a Flatten button for flattening a net position. When the user chooses to flatten, working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

Position information and Market Data is displayed following standard window rules laid out in the Standard Window. The data in this window 60 is displayed in the standard grid format, as described in the Standard Grid.

Table 6 illustrates a list of position information that is available from this window 60. However, the present invention is not limited to this position information and more, fewer or other types of position information can be used to practice the invention.

TABLE 6

Account
Exchange Name
Contract Name
Contract Date
Net Position
Avg. Price
Open P&L
Cumulative P&L
Total P&L
Commission

The GUI 32 will also show market data and position information. The user chooses which fields should be displayed in the grid (i.e., some market data fields will appear by default). Table 7 is a list of market data that is available from this window 60. However, the present invention is not limited to this market data more, fewer or other types of market data can be used to practice the invention.

TABLE 7

```
Exchange Name
Contract Name
Contract Date
Bid Price
Bid Size
Ask Price
Ask Size
Last Traded Volume
Net Price Change
Last Traded Price
High Price
Low Price
Opening Price
Closing Price
Total Traded Volume
Contract Status
    This is the status of the contract on the exchange
    (i.e. open, pre-open, trading, etc.)
```

### Aggregated Book View/Ask Bid Volume (ABV) Window

The ABV Window allows the user to view bid size and offer size by price for a particular instrument in a market depth-type format. As is known in the electronic trading arts, “market depth” is a number of electronic trading instruments (e.g., contracts, financial instruments, etc.) required to move the electronic trading entity price by one “price tick” in a current market. The window displays working orders for a selected account in a single instrument. The data on this window is displayed and updated in real-time. The window also allows the user to enter various order types. In one embodiment, two ABV windows are displayed by default. In another embodiment, one or more than two ABV windows are displayed by default.

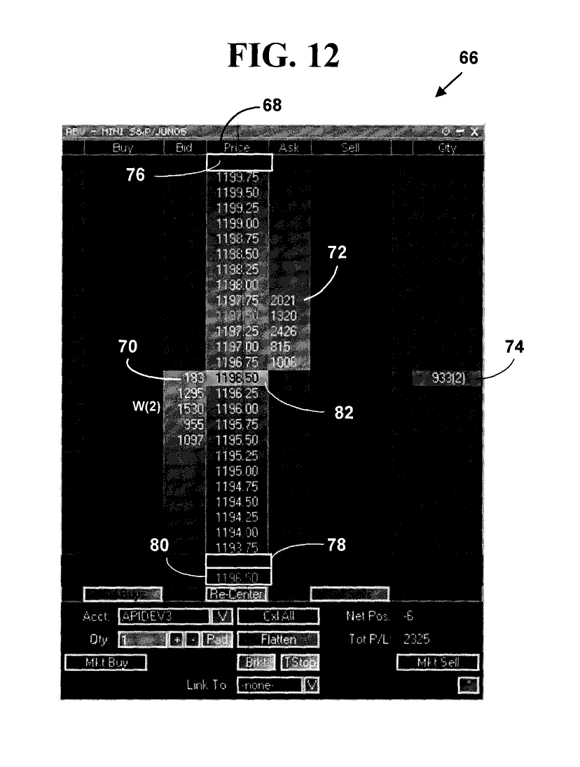

FIG. 12 is a block diagram of screen shot of an exemplary ABV window 66 produced by application 30 displayed on GUI 32. The ABV window 66 includes a dynamically displayed Price column 68.

In one embodiment, the ABV window displays a buy column, a bid column, a dynamic price column, an ask column, a sell column, a quantity column, a re-center button, a cancel buy button, a cancel sell button, a cancel all button, a market buy button, a flatten button, a bracket button, a TStop button, a net position and a total P/L. However, the present invention is not limited to displaying these items and more, fewer or other items can be displayed in the ABV window 66 to practice the invention.

The user can select an instrument or contract to view in an ABV window 66, and can change the instrument or contract from this window 66. Changing the instrument or contract changes the data displayed to that of the selected instrument or contract. The user can select an account from available accounts. The window 66 displays the total quantity of orders working in the market at each price. Both buy and sell quantities are displayed. Quantities are updated as the instrument order book changes. The window 66 displays an indicator depicting the all of the user's open orders, for the selected account, at each price. The window 66 indicates a state of each order. Open order states include, but are not limited to: Queued, Sent, Working, Part Filled, Cancel Pending and Amend Pending, Held, Cancelled, Filled.

This window 66 indicates the order type for each order. The window 66 indicates the working quantity of each order. The window 66 displays parked orders for the selected instrument. The window 66 displays the user's net position in the selected instrument for the selected account. The window 66 displays the trade quantities for each corresponding price level. The user can select to view the total quantity currently trading at a price. This quantity is increased as each trade at a price occurs. The cumulative quantity remains in the window 66 until the price changes (at which time the cumulative trade quantity for the new price will be shown).

The user selects to view the last quantity currently trading at a price. This view shows the individual trade quantities. Only quantities for the current price are shown. The window 66 displays the total traded volume for the instrument. The window 66 displays all of the aforementioned data at once.

The user sets and adjusts the specified quantity for orders entered via this window 66. The quantity is set via a spinner, text entry or keypad entry. Each key-pad input increases a specified quantity by an amount displayed on the key (key value). The user selects to have the specified quantity set to zero after order entry. The user resets the quantity to zero (i.e., without entering an order). A right click on the mouse increases the quantity, left click decreases the quantity.

Orders entered via this window 66 will have a quantity equal to the quantity specified at time of entry. The default account for any orders entered from the ABV window 66 is the selected account. The can enter a limit order by clicking a cell in the bid quantity or offer quantity columns. Limit orders are default order type.

Order side will be set to BUY if the user clicks in the bid quantity column 70. Order side will be set to SELL if the user clicks in the offer quantity column 72. Orders will have a quantity equal to the specified quantity. Order limit price must equal the price corresponding to the clicked offer/bid quantity.

The user enters a stop order by clicking a cell in the bid or offer quantity columns 70, 72. Order side will be set to BUY if the user clicks in the bid quantity column 70. Order side will be set to SELL if the user clicks in the offer quantity column 72. Orders must have a quantity equal to the specified quantity. The order stop price will equal the price corresponding to the clicked offer/bid quantity. The order is entered for the selected account. The user is able to enter a buy stop below the market or a sell stop above the market. If the user does this, a window appears, warning the user that the buy or sell will be immediately executed.

The user can enter an OCO (One Cancels Other) pair of orders. The user can also enter a profit/loss bracket. The user can enter a trailing stop. The user can also enter an “If-Then Strategy.”

The user can change the limit price of a working limit order by dragging the working order indicator to a new price. The user can change the stop price of a working stop order by dragging the working order indicator to a new price. This will cause a cancel replace to be entered at the electronic trading exchange 20, 22. The user can change the quantity of a working order by right clicking in the cell displaying the working order. A right click on a mouse displays a context menu listing order quantities centered on the current quantity. The user can also adjust account number.

The user can cancel a working order with a single mouse click. The user can cancel all open orders in the instrument for the selected account. The can cancel all open buy orders in the instrument for the selected account. The user can cancel all open sell orders in the instrument for the selected account.

Users can have orders at a price displayed as a concatenated total, or displayed as each individual order. When the display of individual orders is to large for the display, individual orders will be displayed starting with the first order entered and then the remaining orders that do not fit in the display will be concatenated. Concatenated orders are indicated as such using a symbol that is attached to the total. Users can also adjust the display of the ABV by adding or removing columns, buttons and functions.

The user uses the open position in the instrument for the selected account. This window 66 includes a Flatten button for flattening the net position. When the user chooses to flatten, all working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

The user can center the dynamic Price column 68 on the current market. The user can scroll the dynamic Price column 68 to display prices above or below the current market. All data is displayed real-time.

This ABV window 66 follows the standard window rules laid out in the Standard Window. The data in this window is displayed in a grid, but this grid will not follow all of the standard grid rules.

The user can choose from a list of columns to display. Certain columns will be displayed by default. Certain columns will not be removable (price for example). The user can change the order of the displayed columns by dragging a column heading to a new position. The user can manually resize a column. The user can resize all columns to fit the screen. The user can resize all columns to fit the contents. The user can resize a selected column to fit the contents. Double clicking on the column heading border sizes a column so that data only is displayed with no redundant space.

The user can change the font for all columns in the grid. The user can change the font for an individual column. The user can change the foreground color of a column. The user can change the background color of a column. The user can restore the default grid settings.

The ABV window 66 is resizable. When it is resized, the columns expand and contract so that all data is still shown. However, after resizing the window, the user can resize the columns to get rid of wasted space and then change the font size (i.e., so it's more readable when the screen is small).

This ABV window 66 will display the following fields illustrated in Table 8 in a ladder format. However, the present invention is not limited there fields and more, fewer or other types of fields can be used to practice the invention.

TABLE 8

Price
Centered on the current market prices when launched.
Market Bid Quantity
Market Offer Quantity
Trade Quantity as determined in section 11.3 above
Open Buy Orders indicating status, type and quantity for each order
Open Sell Orders indicating status, type and quantity for each order
Parked Orders

The ABV window 66 displays real-time data for a particular contract, allowing a user to get a current snapshot of the market. Thus, the ABV window 66 can also be considered an “Ask, Bid, Volume” window.

An instrument or contract can be added to an open ABV window 66 in the same way that a contract was added to the Quotes window 50. Simply select the contract that to display and then drag it into the ABV window 66. Contracts can be dragged from any of the windows displayed on the screen.

Once a contract has been added to the ABV window, the data illustrated in Table 9 is displayed on the ABV window.

TABLE 9
A current number of Bids 70 and Asks 72 on an electronic trading exchange 20, 22 for
particular price levels.
A total quantity currently trading at a certain price.
A number in parentheses 74 next to the total quantity is the last quantity traded at that
price.
A price in red is the daily high 76. A price shown in blue is the daily low 78. A last traded
price is shown in gray 80.
The last traded price 82 is also highlighted on a dynamic price column 68. When there
has been an uptick in this price, this cell will be green. When there has been a downtick,
this cell will be red. If there has been no change, this cell will appear yellow.
The Buy and Sell columns display a total number of open orders at each particular price.
For example, a “W2” in the Buy column indicates that there are working orders with a
total quantity of two at the specified price.
Net Position and Total P/L on the ABV can be monitored by simply referring to the lower
right hand corner of the window.

On the ABV window 66, the price of any open Buy or Sell orders can be amended. To change the price of an order, a row selector that corresponds with the order to amend is selected buy left-clicking and holding down a left mouse button, dragging a cursor connected to the mouse up or down to a desired new price and releasing the mouse button. A white cursor arrow appears to indicate a change in price. The price amended will be submitted as soon as the mouse is released. If there multiple orders at the same price (and on the same side), all of the orders will be amended to the new price when dragging the concatenated order. The user can cancel a signal order at a price where multiple orders exist. They can also modify a single order at a price where multiple orders exist. They do this by selecting the individual order and dragging and dropping.

Another feature of the ABV window 66 is that a desired position on the dynamically displayed Price column 68 can be moved. If it is desired to scroll up or down on a market price on the dynamically displayed Price column 68, the dynamically displayed Price column 66 is hovered over with a mouse. A yellow cursor arrow will appear, pointing up if the mouse cursor is in the top half of the dynamic price column 68, or down, if the mouse cursor is in the bottom half of the dynamic Price column 68. Clicking on the cursor arrow will scroll the grid in the direction that the arrow points.

The ABV window 66 provides a dynamic Price column 68 centered upon the lasted traded price that continuously changes with fluctuations in the last traded price. To enter an order, a mouse cursor is hovered anywhere in the ABV window 66. This mouse hover puts a user in the “order entry mode.” In the order entry mode a trade near last traded price can be entered or prices on the dynamic price column can be manually adjusted away from the last traded price. To scroll up or down the market prices on the dynamic Price column 68 to enter a trade, the mouse cursor is hovered over the dynamic Price column 68. A large yellow arrow will appear, pointing up if the mouse curser is in the top half of the dynamic price column, or down, the mouse cursor is in the bottom half of the dynamic price column. Clicking on the large yellow arrow will scroll the prices in the dynamic price column in the direction that the large arrow points so a trade can be entered away from a current market price.

If the dynamic Price column 68 is scrolled up or down and the last traded price is not centered on your ABV, the dynamic price column will start to scroll until the last traded price is again centered in the ABV window 66. In addition, if there is no further activity from a mouse for a period of time the dynamic Price column 68 will also start to scroll. As a visual indication, just before the dynamic price column begins to scroll, the mouse cursor will turn yellow and start to flash. This is a warning that the ABV window is about to begin re-centering around the last traded price. If, at any time, the mouse cursor is moved out of the ABV window, you leave the order entry mode and the ABV will automatically re-center the dynamic price column on the last traded price the next time the market price changes.

Stop and limit orders can also be entered on the ABV window 66 with just a click of a mouse. Before entering limit or stop orders an account is chosen and a quantity is entered. If a user has access to multiple accounts, the user can select the desired account by using the Account drop down menu. The user can input a number of lots to trade by typing the number in, by using the + or − buttons, or by using a keypad. A default quantity can be set via the Settings window. After selecting an account and quantity, limit and stop orders can be placed.

To enter a Buy Limit order, the mouse is clicked in the Bid column next to the Price to enter the order for. A limit order to buy will be entered at that price for the quantity specified, and a new working order will be reflected in the Buy column. Likewise, to enter a Sell Limit order, the mouse is clicked in the Ask column next to the Price to enter the order for.

To enter a Buy Stop order, the mouse is right-clicked in the Bid column next to the Price to enter the order for. A stop order to buy will be entered at that price for the quantity specified, and a new order will be reflected in the Buy column. Similarly, to enter a Sell Stop order, the mouse is right-clicked in the Ask column next to the Price that you want to enter the order for.

In addition to Limit and Stop orders, Market orders can be executed on the ABV window 66 using the Market Buy and Market Sell buttons. The ABV window can also be set up so that a Bracket or Trailing Stop order will automatically be created any time an order entered via the ABV is filled. The Bracket and Trailing Stop parameters will default to the values set up on the Settings window. To link a Bracket or Trailing Stop order to all orders entered via the ABV, choose Bracket or TStop from the Link To drop down box. A small window pops up with the default parameters for a bracket. The bracket levels can be changed by typing in a desired number, or using the “+” and “−” buttons. A limit order will be the profit order type, and for a loss order type, either choose a stop or a trailing stop can be selected.

For example, if a stop order is chosen, as soon as the order was filled, two new orders were entered. A limit order was created at a price that is five ticks above the market order's price and a stop order was created at a price that is three ticks below the market order's price Both orders have the same quantity that the market order had. Because these orders were entered as part of a bracket, when one of these orders is filled, the other will automatically be cancelled. Likewise, TStop is chosen from the Link To drop down box, a small window will appear that allows you to view and change trailing stop parameters. Like the bracket, a trailing stop will be entered once an order entered via the ABV window 66 is filled.

The ABV also allows cancellation of some or all of working orders as well. To cancel a particular order, the mouse cursor is placed over that order in the Buy or Sell column, whichever applies, and a yellow X appears over the working order. A mouse click on the yellow X will cancel that particular order. If multiple orders are entered at the same price (and on the same side), they will all be cancelled.

### Order Ticket Window

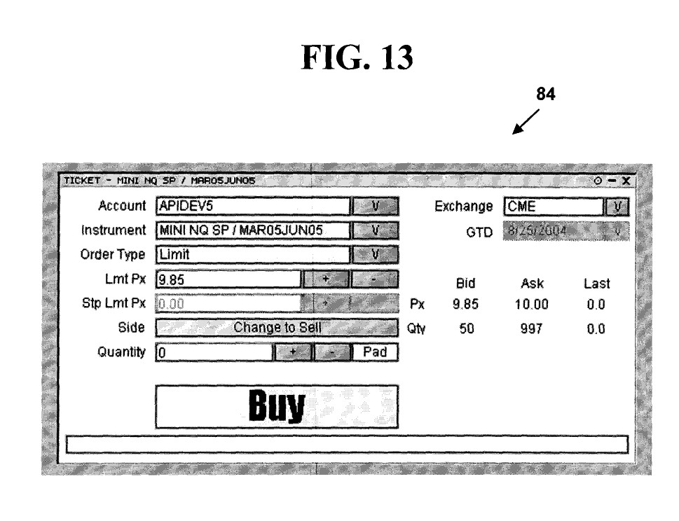

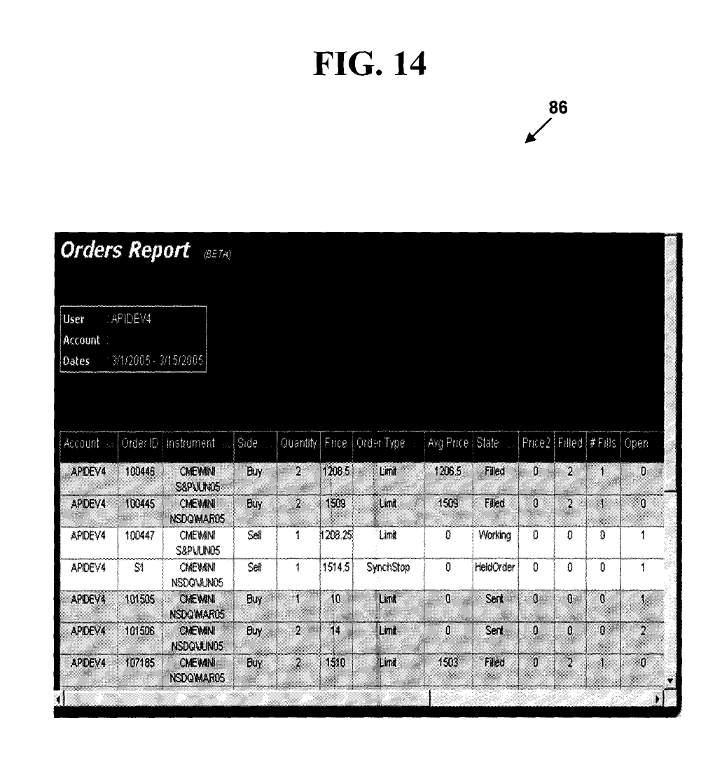

FIG. 13 is a block diagram of screen shot of an exemplary Order Ticket window 84 produced by application 30 and displayed on GUI 32. This window 84 allows the user to create and enter all types of orders supported by the application and the APIs used. This window 84 is accessible via all windows except for Login, Settings, Client Messaging and Reports windows. Multiple order tickets can be launched and multiple windows 84 will be created. The Order Ticket window 84 is a member of a Desktop Layout. Order types, including Synthetic order types can be entered from this window.

In one embodiment, the Order Ticket window 84 displays, but is not limited to, an account identifier, an instrument or contract identifier, an order type, a limit price, if any, a stop limit price if any, a side identifier, a quantity identifier, an exchange identifier a current bid, ask, and last traded price, a current bid, ask or last traded quantity and a buy or sell identifier. However, the present invention is not limited to displaying these items and more, fewer or other items can be displayed in the Order Ticket window 84 to practice the invention.

If necessary, the Order Ticket window 84 will change or launch supporting windows to accommodate more complex order types. In one embodiment, the Order Ticket window 84 displays, but is not limited to, an account identifier, an instrument or contract identifier, an order type, a limit price, if any, a stop limit price if any, a side identifier, a quantity identifier, an exchange identifier a current bid, ask, and last traded price, a current bid, ask or last traded quantity and a buy or sell graphical button. However, the present invention is not limited to this embodiment and other embodiments can be used to practice the invention.

The user can select the account that the order applies to. The user can change the side of the order. The ticket background color depends upon the side chosen. For example, the background is set to blue for buy orders and set to red for sell orders. The following market data is displayed, but is not limited to, on this window 84 for the selected instrument: bid price, bid size, ask price, ask size, and last traded price.

This window 84 also does follow the standard window rules laid out in the Standard Window. The window can also be resized. The user can select to have the order ticket always on top. The default for this functionality is determined in the Settings Window. The Order Ticket window 84 is member of a Desktop Layout window. The Order Ticket window 84 settings are saved when it is a member of a Desktop Layout.

This window 84 is comprised of all the fields necessary to enter an order. The field defaults are set in the Settings window 48, but this window 84 may display different defaults depending on where it was launched from (for example, if it was launched from a specific fill or position).

Table 10 illustrate a list of the fields that are used to create a standard order. Synthetic orders also created directly from this window 84. In another embodiment, a separate window may be launched, or there may be some other method of accessing synthetic order entry. However, the present invention is not limited to this order information and more, fewer or other types of order information can be used to practice the invention.

```
TABLE 10
Exchange
  The default value for this field is determined from the window where it
  was launched or in Settings.
Instrument
  This field is filtered to display valid instruments based on the exchange
  that is selected.
Contract Date
  This field is filtered to display valid contract dates based on the
  instrument that is selected.
Order Type
  This field is filtered to display valid order types based on the exchange
  that is selected.
Limit Price
  This field defaults to either the current bid, ask or last as determined by
  Settings and by the side.
  This price does not change once the order is open.
  This field is enabled only for stop, stop limit, MIT orders and the
  synthetic equivalents for those order types.
  The use is able to enter the price via keyboard entry or spinner,
Order Quantity
  The user is able to change the specified order quantity through a
  key-pad control.
  Each key-pad input increases the specified quantity by the amount
  displayed on the key (the key value).
  The user has ability to set the quantity back to zero.
  The user is able to select to have the specified quantity set to zero after
  order entry.
Secondary Price
  This field is enabled only for stop limit orders.
Good-Till-Date
  This field is enabled only for orders with TIF (Time in Force) of GTD.
  This field defaults to the current trade date.
```

### Reports Window

FIG. 14 is a block diagram of screen shot of an exemplary Reports window 86 produced by application 30 displayed by GUI 32. The Reports window 86 allows the user to create and enter all types of orders supported by the application 30 and APIs used. This window is accessible via all windows except for Login, Settings, Client Messaging and Reports. Multiple order tickets can be launched. The order ticket can be a member of a Desktop Layout window.

In one embodiment, the Reports window 86 displays, but is not limited to, an account identifier, an order identifier, an instrument identifier, a side identifier, a quantity, a price, an order type, an average price, a state, a price2, file, number of fills and an open column. However, the present invention is not limited to displaying these items and more, fewer or other items can be displayed in the Reports window 68 to practice the invention.

Order types, including synthetic order types are summarized from this window 86. If necessary, the Order Ticket window 84 changes or launches supporting windows to accommodate more complex order types. The user can select the account that the order applies to. The user changes the side of the order. Ticket background color depends upon the side chosen. For example, the background is blue for buy orders ant he background is red for sell orders.

Table 11 illustrates a list of the fields used to create a standard order report. However, the present invention is not limited to this order information more, fewer or other types of order information can be used to practice the invention.

```
TABLE 11
Exchange
  The default value for this field is determined from the window where it was launched
  or in Settings.
Instrument
  This field is filtered to display valid instruments based on the exchange that is
  selected.
Contract Date
  This field is filtered to display valid contract dates based on the instrument that is
  selected.
Order Type
  This field is filtered to display valid order types based on the exchange that is
  selected.
Limit Price
  This field defaults to either the current bid, ask or last as determined by Settings
  and by the side.
  This price does not change once the order is open.
  This field is enabled only for stop, stop limit, MIT orders and the synthetic
  equivalents for those order types.
  The user is able to enter the price via keyboard entry or spinner.
Order Quantity
  The user is able to change the specified order quantity through a key-pad control.
  Each key-pad input increases the specified quantity by the amount displayed on
  the key (the key value).
  The user has ability to set the quantity back to zero.
  The user is able to select to have the specified quantity set to zero after order
  entry.
Secondary Price
  This field is enabled only for stop limit orders.
Good-Till-Date
  This field is enabled only for orders with TIF (Time in Force) of GTD.
  This field defaults to the current trade date.
  This window allows the user to view and print reports.
Screen Access
  This window is accessed via the Manager window. Multiple report windows
  cannot be launched. The report window is not a member of any Desktop Layout.
Functional Requirements
  No trading functionality is available from this window.
Fill Report
  The user is able to view and print a fill report by account for the current day.
  The data for this report is saved on the client.
Order History Report
  The user is able to view and print an order history report for the current day or for
  any range of time up to 30 days.
  History includes parked orders.
  The data for this report should is on the client machine 30.
Orders Entered Report
  The user is able to view a report showing orders entered that were filled for the
  current day or for any range of time up to 30 days.
  The data for this report is saved on the client.
```

### Client Logs

This functionality allows the user to send error and audit logs. A log of application errors is maintained. Application error logs, created daily, are retained for ten trading days. The user does not have ability to view the application error log. Logs are stored on the client and are not be encrypted, but should not be easily accessible to the user. The user can send the application error log to another location from within the application 30.

An audit log is created. The audit log contains detailed order history, including all available times associated with the order. The log also contains fills associated with the order. The log contains messages pertaining to the application which indicate connection activities and statuses. Audit logs, created daily, are retained for ten trading days. The user does not have ability to view the audit log. Logs are stored on the application 30 and should not be encrypted, but should not be easily accessible to the user. The user can send the audit log to another location from within the network 18.

### Specialized Order Functionality

The application 30 also provides specialized order functionality. This functionality is available to the user wherever orders can be entered. The user creates one-cancels-other (OCO) order pairs. An OCO order is one that allows the user to have two working orders in the market at once With the execution of one order the other is canceled. The user can construct an OCO pair across different instruments traded on a single electronic exchange. The user can construct an OCO pair across different instruments on two electronic trading exchanges. The user can construct an OCO pair combining orders of any order type that is supported by the exchange (or supported synthetic order types).

The user cancels OCO orders before exiting the application 30. If the user has any open OCO's upon logoff, the GUI 32 warns the user that the orders will be cancelled and allow the user to cancel the logoff if desired. By default, entering a quantity for the OCO enters that same quantity for both sides of the OCO.

A complete fill of one order cancels the other order. If there is a partial fill on one leg of the OCO, the other side of the OCO is reduced by the amount that was filled. This functionality will only occur if both legs of the OCO are entered with the same quantity. The user has the ability to turn off this functionality, so that the order quantities don't automatically decrement and the orders are canceled only when one order is completely filled. If the user enters different quantities, this functionality are automatically turned off and disabled.

The user can cancel individual orders of the pair, leaving the remaining order in the market. The user can cancel both orders in the pair simultaneously. The user can change the price for an individual order of the pair. The user can create a profit/loss bracket order pair. A Profit/Loss bracket is a specific case of an OCO order pair. This order pair consists of a limit order to establish a profit and a stop loss order to limit loss. The stop loss portion of the bracket should be able to be a “trailing stop.” The use is able to create a profit/loss bracket around an existing position. The user is able to create a profit/loss bracket around a fill. The use can create a profit/loss bracket around an order in the filled state.

The user can create trailing stop orders. A trailing stop is an order that tracks a price of the instrument and adjusts the stop trigger price in accordance with a predefined rule (i.e., stop trigger is changed when the market changes a certain number of ticks).

Trailing stop orders can be either of type stop or stop limit. For stop limit orders, the limit price will be changed such that it keeps the same differential from the stop trigger price. In order to set up the trailing stop rule, the user must enter: the number of ticks that the market must change before the stop trigger price should be adjusted. The number of ticks that the stop trigger price should be adjusted when an adjustment is warranted. A trailing stop order is purely synthetic.

The stop order should only be known to the client until it is actually triggered. At that time either a market order (in the case of an order type of stop) or a limit order (in the case of a stop limit order) will be entered into the market. A trailing stop only adjusts the stop trigger price in the profitable direction of the trade. A trailing stop order to sell does not adjust the stop trigger price to a value less than the initial trigger value. A trailing stop order to sell only increases the stop trigger price. A trailing stop order to sell only adjusts the stop trigger price when new high prices are traded in the instrument. This will prevent adjusting the stop trigger price if the instrument price retraces a profitable move but does not trigger the stop.

A trailing stop order to buy does not adjust the trigger price to a value greater than the initial trigger value. A trailing stop order to buy only decreases the stop price. A trailing stop order to buy must adjusts the trigger price when new low prices are traded in the instrument. This will prevent adjusting the stop trigger price if the instrument price retraces a profitable move but does not trigger the stop. Trailing stops are only valid while the user is logged into the application 30. Application 30 exit will have the effect of the trailing stop not being in the market. On application exit, if the user has trailing stops entered, the user will be warned that the stop will not be worked while the application is closed.

The user is to choose to save trailing stops. On application 30 launch, the user is advised of any saved trailing stops and given the opportunity to reenter them.

The user is able to create parked orders. A parked order is an order that is created by the user but not submitted to the market. The user is able to release a parked order. Releasing a parked order submits it to the market. The user can change a working order to a parked order. This sends a cancel to the exchange. On receipt of the cancel acknowledgement, the application 30 changes the order state to indicate that the order is parked. Parked orders are saved on application exit. Parked orders are restored on application 30 launch.

### If-Then Strategies

The user can create an “If-Then Strategy.” With an If Then Strategy, an order is entered into the market. Upon receipt of a fill acknowledgement for the order, one or more other orders are automatically entered by the application 30 based on the If-Then strategy. Typically, the orders that are entered with If-Then Strategy will be orders to manage profit and loss expectations for the fill that was received on the original order. The user can create an If-Then strategy where on the receipt of the acknowledgement of an order fill, a profit/loss bracket is entered around the fill price for the filled quantity. The user can create an If-Then strategy where on the receipt of the acknowledgement of an order fill, a stop or stop limit order is entered at an offset from the fill price for the quantity of the fill. The user can create an If-Then strategy where on the receipt of the acknowledgement of an order fill, a trailing stop order is entered at an offset from the fill price for the quantity of the fill. The user can create an If-Then strategy where on the receipt of the acknowledgement of an order fill, a limit order is entered at an offset from the fill price for the quantity of the fill. The user can create an If-Then strategy where on the receipt of the acknowledgement of an order fill, an OCO order pair is entered.

### Automatically Trading Spreads

As is known in the art, a “futures spread” includes a purchase of one futures delivery month contract against the sale of another futures delivery month contract of the same commodity; the purchase of one delivery month contract of one commodity against the sale of that same delivery month contract of a different commodity; or the purchase of one commodity contract in one market against the sale of the commodity contract in another market, to take advantage of a profit from a change in price relationships. The term spread is also used to refer to the difference between the price of a futures month contract and the price of another month contract of the same commodity.

An “intra-commodity” spread (e.g., a calendar spread) is long at least one futures contract and short at least one other futures contract. Both have the same underlying futures contract but they have different maturities.

An “inter-commodity” spread is a long-short position in futures contracts on different underlying futures contracts. Both typically have the same maturity. Spreads can also be constructed with futures contracts traded on different exchanges. Typically this is done using futures on the same underlying contract, either to earn arbitrage profits or, in the case of commodity or energy underlying contracts, to create an exposure to price spreads between two geographically separate delivery points.

A “different commodities spread” is a spread between two or more different commodities contracts of any type of any maturity and any type of position. (e.g., (Mini S&P)/(Mini NSDAQ), or (Mini S&P)/(Mini DJ), etc.).

A “crack spread” is a commodity contract—commodity product contract spread involving the purchase of a commodity and the sale of a product. For example, the purchase of crude oil futures contracts and the sale of gasoline and/or heating oil futures contracts.

Spread trading offers reduced risk compared to trading futures contracts outright. Long and short futures contracts comprise a spread that correlated, so they tend to hedge one another. For this reason, exchanges generally have less strict margin requirements for future contract spreads.

A “butterfly spread” for futures contracts includes a spread trade in which multiple futures contract months are traded simultaneously at a differential. The trade basically consists of two or futures spread transactions with either three or four different futures months at one or more differentials.

Spread trading is also used for options. An option spread trade is when a call option is bought at one strike price and another call option is sold against a position at a higher strike price. This is a called a “bull spread.” A “bear spread” includes buying a put option at one strike price and selling another put option at a lower strike price.

A “butterfly spread” for options includes selling two or more calls and buying two or more calls on the same or different markets and several expiration dates. One of the call options has a higher strike price and the other has a lower strike price than the other two call options. If the underlying stock price remains stable, the trader profits from the premium income collected on the options that are written.

A “vertical spread” for options includes a simultaneous purchase and sale of options of the same class and expiration date but different strike prices. A vertical spread for futures contracts includes a simultaneous purchase and sale of futures contracts with the same expiration date but different prices.

A “horizontal spread” includes the purchase and sale of put options and call options having the same strike price but different expiration dates. A horizontal spread for futures contracts includes the purchase and sale of futures for the same purchase price but different expiration dates.

A “ratio spread” applies to both puts and calls, involves buying or selling options at one strike price in greater number than those bought or sold at another strike price. “Back spreads” and “front spreads” are types of ratio spreads.

A “back spread” is a spread which more options are bought than sold. A back spread will be profitable if volatility in the market increases. A “front spread” is a spread in which more options are sold than bought. A front spread will increase in value if volatility in the market decreases.

The purpose of an option spread trade is two-fold. First, it bets on the direction that a trader thinks a certain stock will go. And second, it reduces a trader's cost of the trade to the difference between what is paid for the option and what profit is obtained from selling the second option. An option profit is the spread, or the difference between the two strike prices, minus a cost of the spread.

An “inter-exchange” spread is a difference in a price of same security, instrument or contract traded on different exchanges. For examples, the price of a stock for a computer of brand-X on the New York Stork Exchange and the Toyko Stock exchanges.

Various types of spreads (e.g., vertical, horizontal, ratio, back, front, etc.) are also used to trade futures contracts, stocks, bonds and other financial instruments and financial contracts in addition to options.

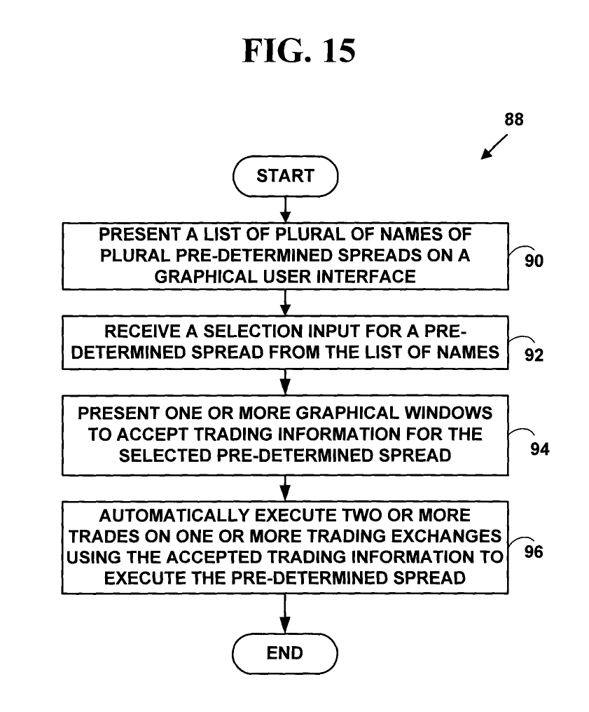

FIG. 15 is a flow diagram illustrating a Method 88 for automatically executing trading spreads. At Step 90, a list of plural names of pre-determined spreads is presented on a graphical user interface. At Step 92, a selection input is received for a pre-determined spread. At step 94, one or more graphical windows are presented to accept information for the selected pre-determined spread. At Step 96, the accepted information is used to automatically execute two or more trades on one or more trading exchanges to execute the pre-determined spread.

Method 88 is illustrated with an exemplary embodiment. However, the invention is not limited to this embodiment and other embodiments can also be used to practice the invention.

In such an exemplary embodiment at Step 90, a list of plural names of pre-determined spreads is presented in a graphical window on GUI 32 via application 30. The list of names of pre-determined spreads includes, but is not limited to, intra-commodity spreads, inter-commodity spreads, crack spreads, butterfly spreads, vertical spreads, horizontal spreads, inter-exchange spreads, synthetic spreads, etc. for futures contracts, stocks, bonds, options, financial instruments and financial contracts.

In one embodiment, the list of names of pre-determined spreads includes a trader defined spread for which a trader can enter a trader-defined spread.

In one embodiment, the list of pre-determined spreads is displayed in a separate spread graphical window. In one embodiment, the list of pre-determined spreads is displayed by application 30 including plural graphical windows as described above.

In such and embodiment, the list of pre-determined spreads is displayed in one or more ABV windows 66 or is displayed in one or more Order Ticket windows 84.

In such embodiment, pre-determined spreads are entered via existing graphical windows (e.g., ABV window 66, Order Ticket window 84, etc.) with using the list of pre-determined spreads. In such an embodiment, a trader creates his/her own spread by entering two or more trades in the pre-existing graphical windows.

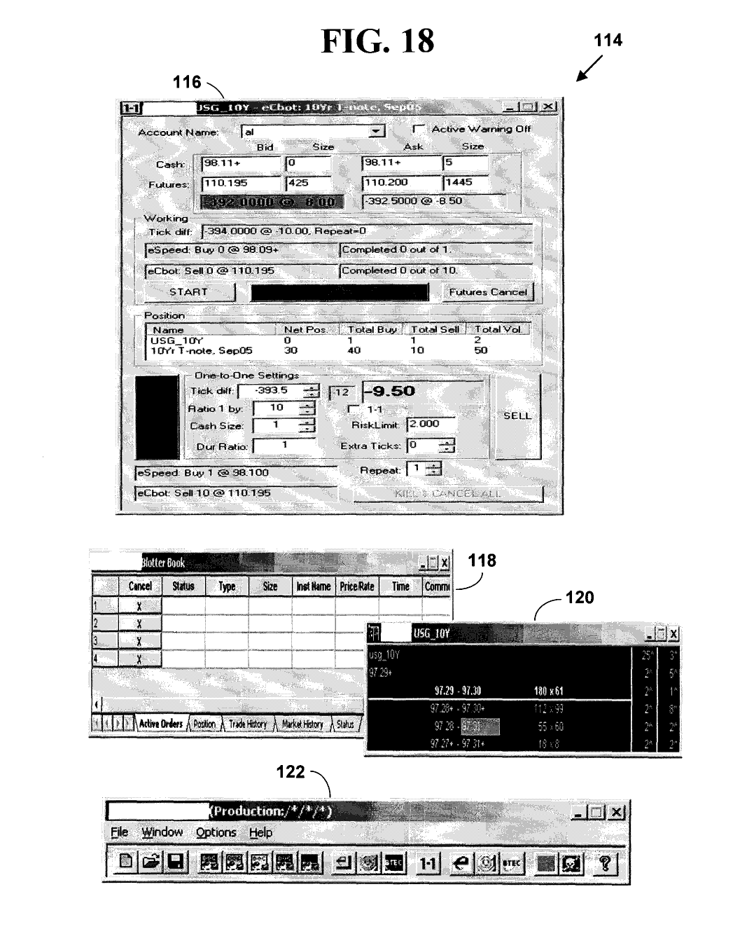

In another embodiment, application 30 is an application used only for spreads In such an embodiment, application 30 displays plural graphical windows created specifically created for trading spreads (e.g., see FIG. 18). In such an embodiment, application 30 also allows dynamically and directly setting up a synthetic spread within the application 30 on the target network device 12, 14, 16. For example, picking two real trading entities (e.g., two real commodities contracts) and a ratio between them and providing a GUI 32 display/order entry for the synthetic spread.

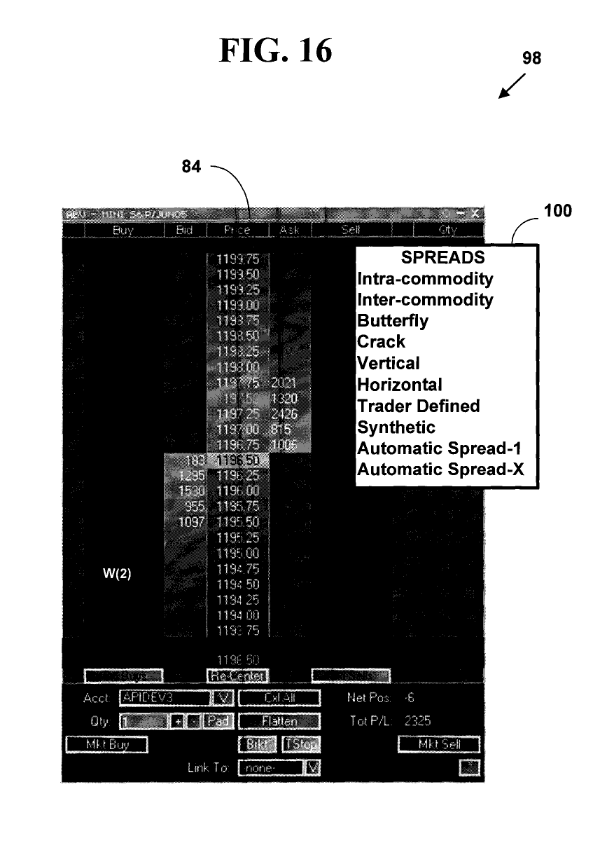

FIG. 16 is a block diagram 98 of a screen shot of an exemplary ABV window illustrating a spread selection window 100.

At Step 92, a selection input is received on the application 30 from a target device 12, 14, 16 for a pre-determined spread for the list of spreads.

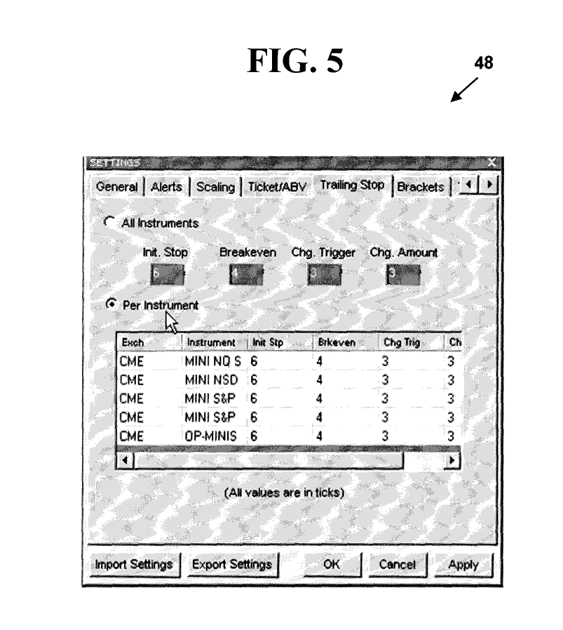

At step 94, one or more graphical windows are presented on the GUI 32 to accept information for the selected pre-determined spread. For example, for an inter-commodities spread, one or more graphical windows illustrated in FIGS. 4-14 (e.g., ABV windows 66, Order Ticket windows 84, etc.) are presented to enter information for the various portions or legs of the spread. In another embodiment, additional specialized graphical spread windows (e.g., see FIG. 18) are displayed and used to accept information for the pre-determined spread.

In one embodiment, selected ones of the pre-determined spreads include configurable slippage factor portion that is pre-determined and configurable trader via the GUI 32. The configurable slippage factor portion allows the trader to safely execute an alternative 2^{nd} leg, 3^{rd} leg, etc. of a trade if an initial primary trade for a futures contract or cash instrument is missed.

In one embodiment, the selected ones of the pre-determined spreads include a configurable duration portion that allows traders to enter “one-to-one”, one-to-multi,” and “multi-to-one” strategies which are may or may not be in pre-determined cash-to-futures ratio, or visa-versa or other contract-to-contract, contract-to-instrument, or instrument-to-contract ratio. For example, the configuration duration portion allows a one-to-one trading strategy for one real cash entity to ten futures real entity ratio, or visa-versa, one real cash entity and eleven real futures entities, or visa-versa, etc. depending on the trader's preferences.

At Step 96, the accepted information is used to automatically execute two or more trades for the pre-determined spread on one or more trading exchanges 20, 22.

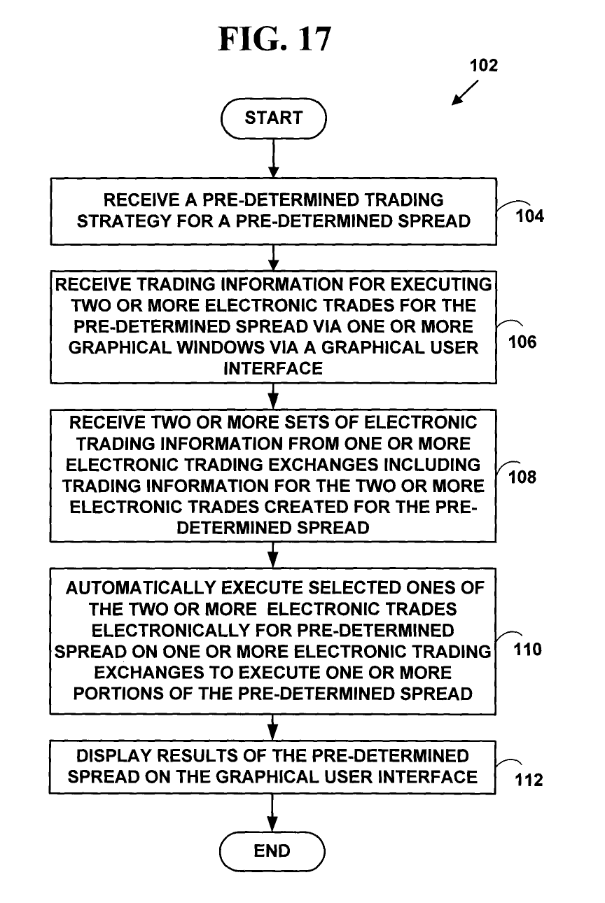

FIG. 17 illustrates a Method 102 for automatically executing trading spreads. At Step 104, a pre-determined trading strategy for a pre-determined spread is received. At Step 106, trading information is received for executing two or more electronic trades for the pre-determined spread via one or more graphical windows via a graphical user interface. At Step 108, two or more sets of electronic trading information are received from one or more electronic trading exchanges including trading information for the two or more electronic trades created for the pre-determined spread. At Step 110, the selected ones or the two or more electronic trades are automatically executed for the pre-determined spread on one or more electronic trading exchanges to execute one or more portions of the pre-determined spread. At Step 112, results of the pre-determined spread are displayed on the graphical user interface.

Method 102 is illustrated with an exemplary embodiment. However, the invention is not limited to this embodiment and other embodiments can also be used to practice the invention.

In such an exemplary embodiment at Step 104, a pre-determined trading strategy for a pre-determined spread is received. As was discussed above, the pre-determined trading strategies include, but are not limited to, a pre-determined trading strategy created by a trader, if-then trading strategies, one-cancels-other (OCO) trading strategies, combinations of buys and sells, combinations of puts and calls, synthetic trading strategies or execution of strategies based on previously executed orders.

In one embodiment, the pre-determined trading strategy is received from a spreadsheet. (e.g., Microsoft Excel, etc.). In another embodiment the pre-determined trading strategy is received from a data file or database file. The spreadsheet, data file or database file may include pre-determined formulas, macros of other entities used to define a trading strategy. In another embodiment, the pre-determined trading strategy is received via manual inputs on a target device 12, 14, 16 via GUI 32 and application 30.

For example, for a synthetic spread a strategy for trading two real trading entities (e.g., two real commodities contracts) and a ratio between them is received.

At Step 106, trading information is received for executing two or more electronic trades for the pre-determined spread via one or more graphical windows such a Spread window, ABV window 66, Order Ticket window 84, etc. via GUI 32 and application 30. In another embodiment, the trading information is received in specialized plural spread windows using a specialized spread application 30 (e.g., see FIG. 18).

In one embodiment, the trading information is received from a spreadsheet. In another embodiment the trading information is received from a data file. In another embodiment, the trading information is received via manual inputs on a target device 12, 14, 16 via GUI 32 and application 30.

At Step 108, two or more sets of electronic trading information are received from one or more electronic trading exchanges 20, 22 including trading information for the two or more electronic trades created for the pre-determined spread.

At Step 110, selected ones of the two or more electronic trades are automatically executed for the pre-determined spread on one or more electronic trading exchanges 20, 22 to execute one or more portions of the pre-determined spread.

At Step 112, results of the pre-determined spread are displayed on the GUI 32 via the application 30. In one embodiment, results of trading on the pre-determined spread are displayed in colors different than other types of trades displayed in the various graphical windows of the GUI 32.

FIG. 18 is a block diagram 114 illustrating plural specialized plural graphical windows 116, 118, 120, 122 displayed from a specialized spread application 30. The plural graphical windows include a main input window 116, a blotter window 118, a market data window 120 and a toolbar window 124 specifically designed for inputting and trading spreads. However, the invention is not limited to this embodiment and more, fewer and other windows can also be displayed by the specialized spread application 30.

In one embodiment, the GUI 32 also includes a graphical spread Profit and Loss (P&L) blotter that provides spread risk monitoring at a firm, group, or trader level. The application 30 calculates and displays spread P&L on a real-time basis on the GUI 32 with Market-to Market and types of spread functionality. The application 30 includes firm wide status messages that can be broadcast to all traders who are viewing a graphical spread blotter and it will illustrate actual spread cumulative P&L and not just intra-day by including previous days total spread positions (i.e., inter-day results, etc.).

In one embodiment, application 30 and GUI 32 include setting up and displaying synthetic market data for a synthetic spread (e.g., an ABV window 66 of the synthetic spread displaying the synthetic contracts price/depth, or a Quotes window 50 entry displaying the synthetic contracts price or specialized windows (e.g., FIG. 18)).

In one embodiment, results of the trades for the pre-determined spread are displayed in a spreadsheet, data file or database file. In such an embodiment, results of trades for the pre-determined spread are written back into the spreadsheet, data file, or database file for display. In such an embodiment, the spreadsheet, data file or database file may be displayed in a new graphical window or as a portion of an existing graphical window (e.g., Spread window, ABV window 66, Order ticket window 84, specialized spread trading windows 116-122 (e.g., FIG. 18), etc.).

### Automatic Determination of One or More Portions of a Trading Spread

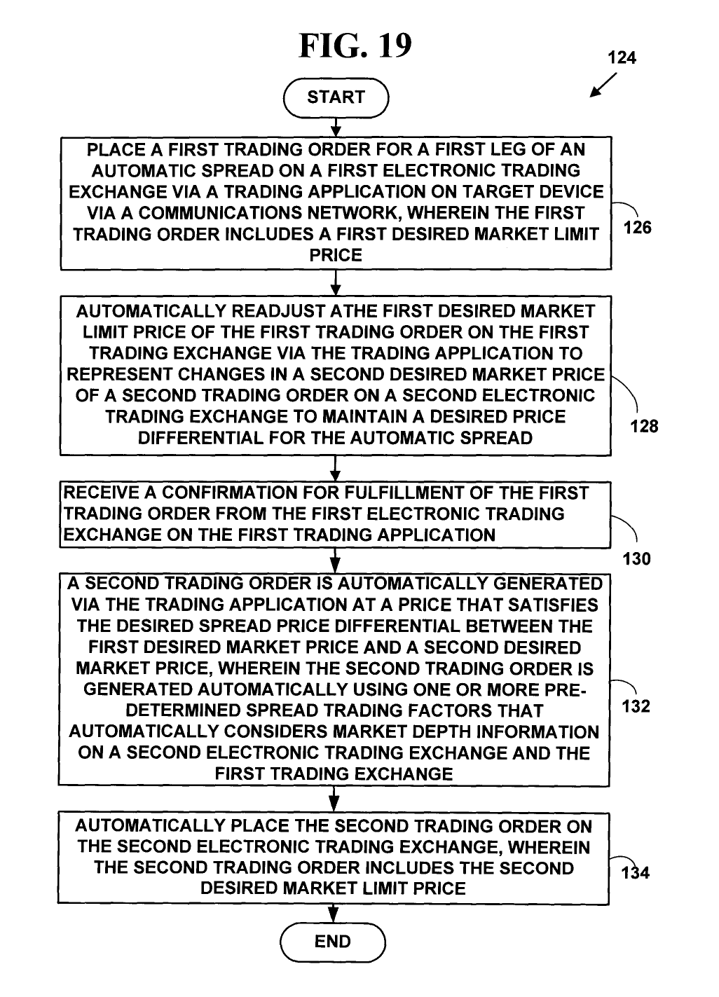

FIG. 19 is a flow diagram illustrating a Method 124 for automatically executing trading spreads. At Step 126, a first trading order for a first leg of an automatic spread is placed on first electronic trading exchange via a trading application on target device via a communications network. The first trading order includes a first desired market limit price. At Step 128, a price of the first desired market limit price of the first trading order is automatically adjusted using pre-determined spread calculations on the first electronic trading exchange using market depth information to represent changes in a desired second market price of a second trading order to continuously satisfy a desired spread price differential. The automatic spread includes real or synthetic trading entities. At Step 130, a confirmation for fulfillment of the first trading order is received from the first electronic trading exchange on the target device. At Step 132, a second trading order is automatically generated via the trading application at a price that satisfies the desired spread price differential between the first desired market price and a second desired market price. The second trading order is automatically generated automatically using one or more pre-determined spread factors which consider market depth information on a second trading exchange and the first trading exchange. At Step 134, the second trading order is placed on the second electronic trading exchange. The second trading order includes the second desired market limit price.

Method 124 is illustrated with an exemplary embodiment. However, the invention is not limited to this embodiment and other embodiments can also be used to practice the invention.

In such an exemplary embodiment at Step 126, a first trading order for a first leg of an automatic spread is placed on a first electronic trading exchange (e.g., 20, etc.). via a trading application including the specialized spread application 30 on target device 12, 14, 16 via a communications network 18. The automatic spread includes real or synthetic trading entities.

In one exemplary embodiment, additional automatic spreader functionality is built into application 30 that presents a graphical user interface (GUI) 32 for electronic trading as described above. The automatic spreader functionality automatically seeks new automatic spreading opportunities by entering one side of an automatic spread into an electronic trading market at a price based a current market price of a second contract.

At Step 128, a price of the first desired market limit price of the first trading order is automatically adjusted using pre-determined spread calculations on the first electronic trading exchange 20 using market depth information to represent changes in a desired second market price of a second trading order to continuously satisfy a desired spread price differential. The automatic spread includes real or synthetic trading entities. Exemplary pre-determined spread calculations are illustrated in Tables 12-17. However, the present invention is not limited to the pre-determined spread calculations and more, fewer or other pre-determined spread calculations can also be used to practice the invention.

In one embodiment, when a first side of an automatic spread in the market (e.g., the “working leg” or first trading order) is filled via first trading order, a second trading order is auto-generated and submitted to an appropriate electronic trading exchange 20, 22 for execution at a price that satisfies a desired spread price differential of two trading instruments (e.g., contracts, etc.) for the automatic spread. The goal is to automatically establish positions of opposite sides in two or more trading instruments at a desired price differential defined by an automatic spread price. This helps remove a level of complexity for traders who desire to trade spreads electronically.

At Step 130, a confirmation for fulfillment of the first trading order is received from the first electronic trading exchange 20 on the target device 12, 14, 16.

At Step 132, a second trading order is automatically generated via the trading application 30 for at a price that satisfies a desired spread price differential between the first desired market price and a second desired market price for the automatic spread. The second trading order is automatically generated automatically using one or more pre-determined spread factors (e.g., spread lean factor, etc.) which considers market depth information on a second trading exchange (e.g., 22, etc.) and the first trading exchange 20.

In one embodiment, the one or more pre-determined spread factors include a spread lean 142 factor. The spread lean 142 factor is used to automatically consider market depth information. However, the present invention is not limited to such an embodiment and other embodiments without using the spread lean 142 factor can also be used to practice the invention.

At Step 134, the second trading order is automatically placed on the second electronic trading exchange 22. The second trading order includes the second desired market limit price. In one embodiment, the second electronic trading exchange is the same as the first electronic trading exchange. In another embodiment, the second electronic trading exchange is different than the first electronic trading exchange.

Method 124 has been described for only two trading orders. However, the present invention is not limited to two spread legs and two trading orders and more than two trading legs and more than two trading orders can also be used to practice the invention. The trading orders can be place for real as well as synthetic trading entities.

In one embodiment, the first trading order is a set of plural trading orders and the second trading order is a set of plural trading orders. In such an embodiment, automatic spread calculations are done for and/or between members of the sets.

In one embodiment, of the invention, application 30 includes specialized automatic spread calculations for automatically adjusting the first and second desired market price limits, the desired spread price differential and other pricing factors.

Tables 12 through 17 illustrate exemplary automatic spread trading calculations for one specific embodiment of the invention. However, the present invention is not limited to such a specific exemplary embodiment and more, fewer or other calculations can also be used to practice the invention.

TABLE 12

| | |
|---|---|
| Custom Automatic | A combination of two or more trading instruments |
| Spread | in which one instrument is bought and the other is |
| | sold to establish offsetting positions in each |
| | instrument to capitalize on an arbitrage |
| | opportunity. |
| Spread Side | To buy or sell a custom spread. Assumes that |
| | when buying a spread Leg I is bought and Leg 2 |
| | is sold. |
| L1 | The first leg of a spread transaction. When a |
| | custom spread is purchased L1 is bought |
| | in the market. |
| L2 | The second leg of a spread transaction. When a |
| | custom spread is purchased L2 is sold |
| | in the market. |
| SPx | Price of the Custom spread. The net differential |
| | between the price of L1and L2 taking |
| | into account the ratios of the two legs. |
| L1Px | Price of L1 instrument. |
| L2Px | Price of L2 instrument. |
| SQty | The number of custom spreads to be bought |
| | or sold. |
| L1Qty | The number of the first leg instruments to be |
| | bought or sold. |
| L2Qty | The number of the second leg instruments to |
| | be bought or sold. |
| L2OrderQty | The number of Leg2 instruments to be bought |
| | or sold on the next order. |
| L1Total FillQty | Total number of instruments filled in Leg1 for |
| | this spread order. |
| L2TotalOrderQty | Total number of instruments submitted for |
| | Leg2 for this spread order. |
| L1FillPx | Price of a fill for Leg1. |
| L2FillPx | Price of a fill for Leg2. |
| L1 MinTick | Minimum Tick value for Leg1 instruments. |
| L2 MinTick | Minimum Tick value for Leg2 instruments. |
| PxFactor1 | A scalar of L1Px to allow normalization of |
| | prices between L1Px and L2Px |
| PxFactor2 | A scalar of L2Px to allow normalization of |
| | prices between L1Px and L2Px. |
| QtyFactor1 | A scalar of L1 Qty to allow normalization of |
| | instrument sizes between L1 and L2. |
| QtyFactor2 | A scalar of L2Qty to allow normalization of |
| | instrument sizes between L1 and L2. |
| Slippage | Number of market depth price ticks added |
| | and/or subtracted to the price of the order |
| | entered into for the |
| | opposing instrument. |
| Lean | A spread lean factor is a multiplier for a number |
| | of instruments (e.g., contracts, etc.) bid and/or |
| | offered in one instrument (e.g., contract, etc.) |
| | for one leg of the automatic spread for another |
| | trading order to be maintained in another leg of |
| | the automatic spread determined using market |
| | depth information. |

TABLE 13

| | |
|---|---|
| Spread Price | SPx = L1Px − (L2Px * PxFactor2)/PxFactor1 |
| Leg 1 Price | L1Px = SPx + (L2Px * PxFactor2)/PxFactor1 |
| Leg 2 Price | L2Px = (L1Px − Spx) * PxFactor1/PxFactor2 |
| Leg 1 Qty | L1Qty = SQty * QtyFactor1 |
| Leg 2 Qty | L2Qty = SQty * QtyFactor2 |

TABLE 14

| Buy Spread | Buy Spread - Work Leg1 | Buy Spread - Work Leg2 |
|---|---|---|
| L1Side | BUY | BUY |
| L1Px | SPx + (L2BidPx * PxFactor2)/ | [SPx + (L2FillPx * PxFactor2)/ |
| | PxFactor1 | PxFactor1] + Slippage * L1MinTick |
| L1Qty | SQty * QtyFactor1 | RoundUp[(QtyFactori * L2TotalFillQty/ |
| | | QtyFactor2) − L1TotalOrderQty] |
| L2Side | SELL | SELL |
| L2Px | [(L1FillPx − Sx) * PxFactori/ | (L1 AskPx − Spx) * PxFactori/ |
| | PxFactor2] − Slippage * L2MinTick | PxFactor2 |
| L2Qty | [(Li FillPx − Spx) * PxFactori/ | SQty * QtyFactor2 |
| | PxFactor2] − Slippage * L2MinTick | |
| | RoundUp[(QtyFactor2 * L1TotalFillQty/ | |
| | QtyFactor1) − L2TotalOrderQty] | |

TABLE 15

| Sell Spread | Sell Spread - Work Leg1 | Sell Spread - Work Leg2 |
|---|---|---|
| L1Side | SELL | SELL |
| L1Px | SPx + (L2AskPx * PxFactor2)/ | [SPx + (L2FillPx * PxFactor2)/ |
| | PxFactor1 | PxFactor1] + Slippage * L1 MinTick |
| L1Qty | SQty * QtyFactor1 | RoundUp[(QtyFactor1 * L2TotalFillQty/ |
| | | QtyFactor2) − L1TotalOrderQty] |
| L2Side | BUY | BUY |
| L2Px | [(LI FillPx − Spx) * PxFactor1/ | (L1 BidPx − Spx) * PxFactorI/PxFactor2 |
| | PxFactor2] + Slippage * L2MinTick | |
| L2Qty | RoundUp[(QtyFactor2 * L1TotalFillQty/ | SQty * QtyFactor2 |
| | QtyFactor1) − L2TotalOrderQty] | |

TABLE 16
Automatic BID and ASK Quanty and Price Calculations

| | |
|---|---|
| SBidPx | L1BidPx − (L2AskPx * PxFactor2)/PxFactor1 |
| SBidQty | Min[L1BidQty\QtyFactorL1, L2AskQty\QtyFactorL2] |
| SAskPx | L1AskPx − (L2BidPx * PxFactor2)/PxFactor1 |
| SAskQty | Min[L1AskQty\QtyFactorL1, L2BidQty\QtyFactorL2] |

In one embodiment, automatic spreads are defined by the user via existing an Ask Bid Volume (ABV) windows 66, Spread windows 116-122, or an automatic Spread Definition window 136.

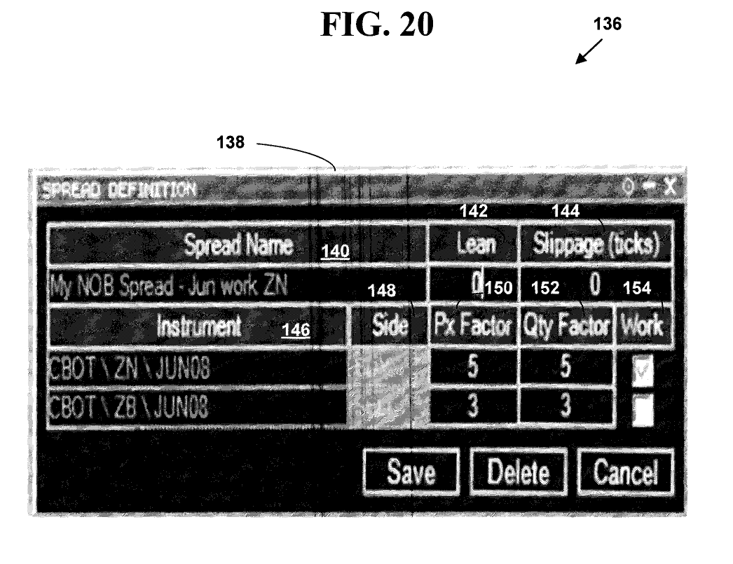

FIG. 20 is a block diagram 136 illustrating a screen shot of an automatic Spread definition window 138. The automatic Spread definition window 138 includes plural components including, but not limited to, a spread name 140, a spread lean 142, a spread slippage 144, a spread instrument 146, a spread side 148, a spread price (Px) factor 150 and a spread Quantity (Qty) factor 152, and a check box 154 component. Check box component 154 is used to select which side of the spread is the working side or non-automatically generated side of the automatic spread. The spread lean 142 factor is explained in further detail below.

In FIG. 20 an exemplary spread name 140 includes “My Nob Spread Work ZN”, the spread lean 142 is zero, the working leg 154 instrument 146 is “CBOT\ZN\JUN08” (i.e., Chicago Board of Trade (CBOT) 10 Year U.S. Treasury Notes Futures (ZN)), with a spread side 148 of buy, the non-working leg instrument 146 is “CBOT\ZB\JUN08” (i.e., Chicago Board of Trade (CBOT) 30 Year U.S. Treasury Bonds Futures Time & Sales Spreads (ZB)) with a spread side 148 of sell.

These plural components are illustrated in Table 17. However, the Spread definition window 136 is not limited to these components and more, fewer or other components can also be used to practice the invention.

TABLE 17
Spread Definition Window 138 Input Definitions

| | |
|---|---|
| 1. | Spread Name 140 - User defined descriptive name of an automatic spread. This name |
| | will appear in the Contracts Window 50, ABV window 66 other windows with a unique |
| | assigned color. |
| 2. | Spread Lean 142 - The lean factor is a multiplier for a number of instruments (e.g., |
| | contracts, etc.) bid and/or offered in one instrument (e.g., contract, etc.) for one leg of |
| | the automatic spread for another trading order to be maintained in another leg of the |
| | automatic spread determined using market depth information. |
| 3. | Slippage 144 - Number of market depth price ticks to be added and/or subtracted to |
| | the second instrument (e.g., contract) order to help ensure execution of that order in |
| | the market. |
| 4. | Instrument 146 - Names of two or more instruments that make up the spread. User |
| | drags and drops the instrument name from other windows 52-66, 84-88 116-122, or the |
| | Contracts Window 50. |
| 5. | Side 148 - Indicates which legs are to be bought when the spread is bought and |
| | sold when the spread is sold. |
| 6. | Px Factor 150 - Scalar value for determining a spread price. |
| 7. | Qty Factor 152 - Scalar value for determining the number of instruments for a |
| | spread. |
| 8. | Working 154 - Check box for selecting the working leg or non-automatic leg of the |
| | spread. |

Once the automatic spread is defined and saved, the spread will be visible in the Contracts window 50 and listed under pre-determined title (e.g., “Spread—Custom Spread Contracts”).

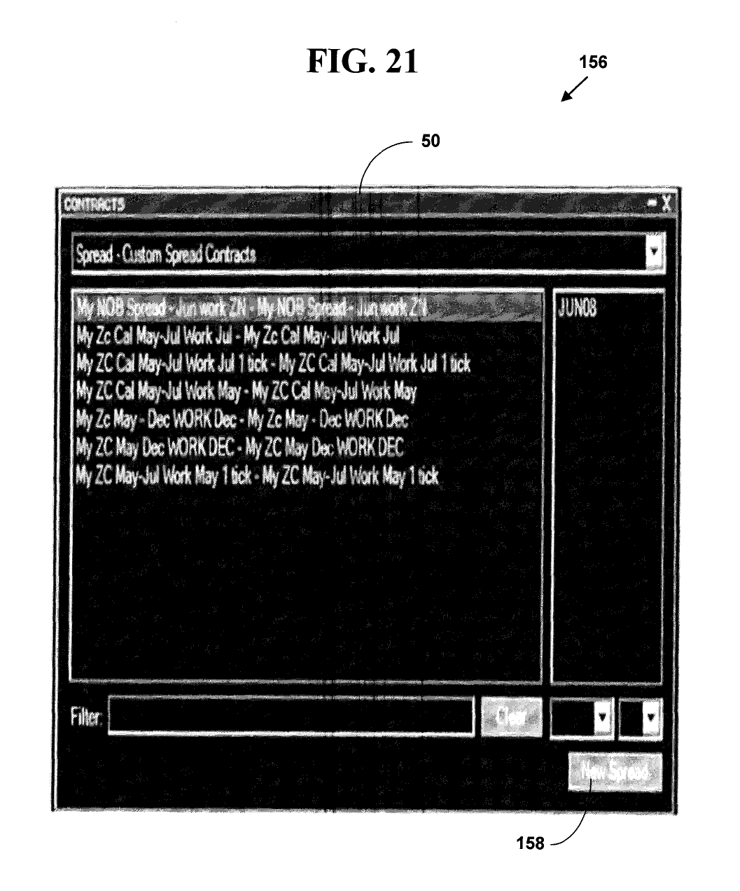

FIG. 21 is a block diagram 156 illustrating a screen shot of an exemplary Contracts window 50 displaying automatic spread information. The Contracts window 50 includes a graphical button 158 for adding new pre-determined or automatic spreads. In this window the automatic spreads are illustrated with the text “Custom Spread Contracts.”

In addition, the spread is listed in the spread selection window 100 (e.g., Automatic Spread-1-Automatic Spread-X, etc.) viewable via the ABV window 66 and in the spread window 116. Users can also drag and drop the custom spread from the automatic spread window 136 into an AVB window 66 display to show the current depth of market of the spread. From the ABV window 66 or other windows 50-66, 84-88 116-122, displaying the custom spread market depth, the user can enter an “order” for the automatic spread in the same manner that any other order or non-automatic spread is entered via the spread selection window 100 of the ABV window 66. As is known in the electronic trading arts, “market depth” is a number of electronic trading instruments (e.g., contracts, financial instruments, etc.) required to move the electronic trading entity price by one “price tick” in a current market.

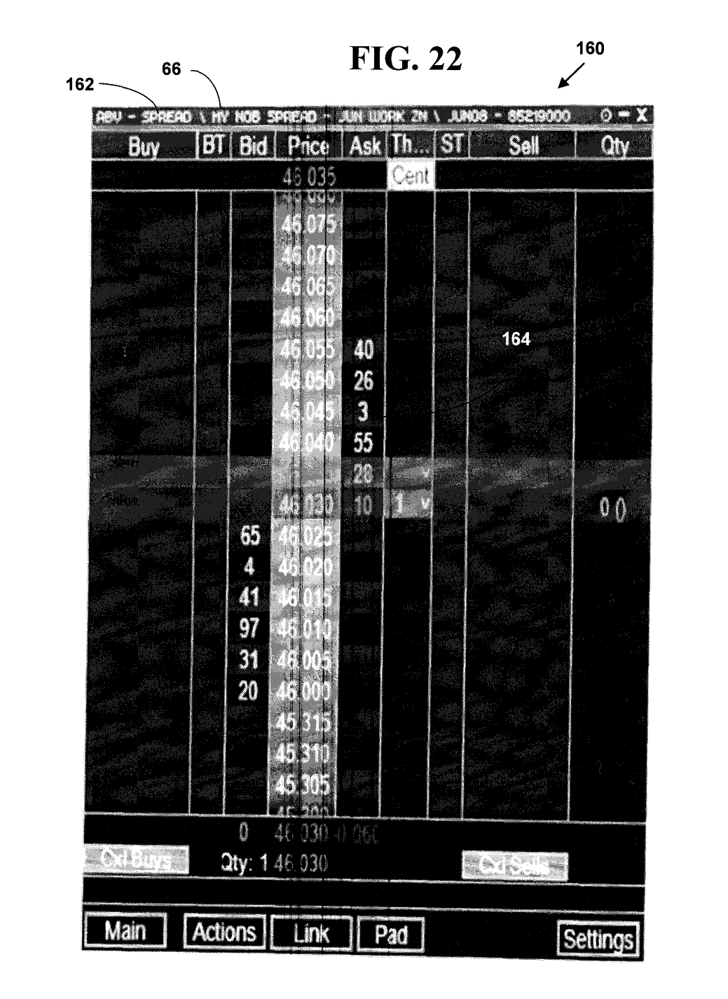

FIG. 22 is a block diagram 160 illustrating a screen shot of an exemplary ABV window 66 displaying automatic spread information 162 and including market depth information 164.

In one embodiment of the invention, a unique display color is assigned to the automatic spread. The assigned unique color for is displayed for components of the automatic spread in a plural different graphical windows on a GUI 32, wherein the components of the automatic spread can be recognized by the assigned unique color in the plural different graphical windows 50-66, 84-88 116-122 on the GUI 32.

For example, and automatic spread may be assigned a purple color and this purple color is unique for components of the spread. The unique purple color is easily recognized in the plural different graphical windows 50-66, 84-88 116-122 on the GUI 32

Entering an “order” for a custom spread causes the application 30 to submit an order to a live market for the active leg at a price determined by the desired spread price differential and the current market price of the opposing instrument. The automatic spreader will then monitor this working order and adjust the first desired limit price appropriately based on the desired spread differential and the current market of the second leg.

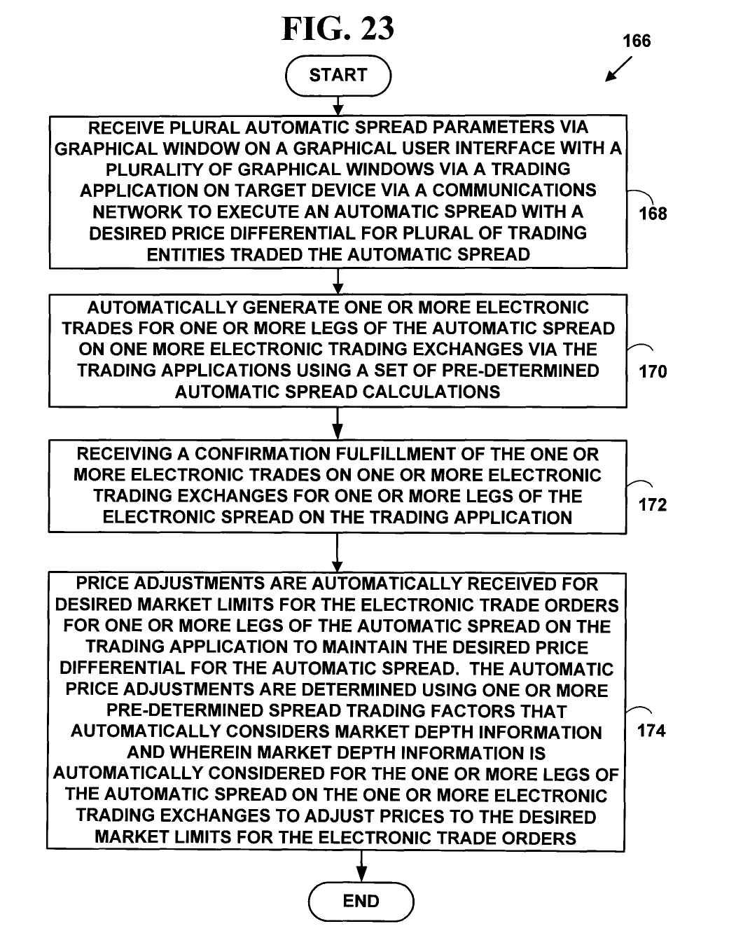

FIG. 23 is a flow diagram illustrating a Method 166 for automatically executing trading spreads. At Step 168, plural automatic spread factors s are received via a graphical window on a graphical user interface with plural graphical windows via a trading application on target device via a communications network to execute an automatic spread with a desired price differential for a plural trading entities traded for the automatic spread. The automatic spread includes real or synthetic trading entities. At Step 170, one or more electronic trades for one or more legs of the automatic spread on one or more electronic trading exchanges are automatically generated via the trading applications using a set of pre-determined automatic spread calculations. At Step 172, a confirmation of fulfillment of one or more electronic trades on one or more electronic trading exchanges for one or more legs of the electronic spread is received on the trading application. At Step 174, price adjustments are automatically received for desired market limits for the electronic trade orders for one or more legs of the automatic spread on the trading application to maintain the desired price differential for the automatic spread. The automatic price adjustments are determined using one or more pre-determined spread trading factor that automatically considers market depth information and wherein market depth information is automatically considered for the one or more legs of the automatic spread on the one or more electronic trading exchanges to adjust prices to the desired market limits for the electronic trade orders.

Method 166 is illustrated with an exemplary embodiment. However, the invention is not limited to this embodiment and other embodiments can also be used to practice the invention.

In such an exemplary embodiment at Step 168, plural automatic spread factors such as those illustrated in Table 17 are received via the Spread definition window 136 the on the GUI 32 via the trading application 30 on target device 12, 14, 16 via a communications network 18 to execute an automatic spread with a desired price differential for a plural trading entities traded for the automatic spread. The automatic spread includes real and/or synthetic trading entities.

At Step 170, one or more electronic trades for one or more legs of the automatic spread on one more electronic trading exchanges 20, 22 are automatically generated via the trading application 30 using a set of pre-determined automatic spread calculations including those illustrated in Tables 12-16.

At Step 172, a confirmation of fulfillment of one or more electronic trades on one or more electronic trading exchanges 20, 22 for one or more legs of the electronic spread is received on the trading application 30.

At Step 174, price adjustments are automatically received for desired market limits for the electronic trade orders for one or more legs of the automatic spread on the trading application to maintain the desired price differential for the automatic spread. The automatic price adjustments are determined using a pre-determined spread trading factor that automatically considers market depth information and wherein market depth information is automatically considered for the one or more legs of the automatic spread on the one or more electronic trading exchanges to adjust prices to the desired market limits for the electronic trade orders.

In one embodiment, one or more pre-determined spread factors include a spread lean 142 factor. The spread lean 142 factor is used to automatically consider market depth information on one or more trading exchanges. However, the present invention is not limited to this embodiment, and more or other pre-determined spread factors can also be used to practice the invention.

For example, in one embodiment, at time T1 electronic trades for a first leg of an automatic spread are automatically adjusted considering market depth information on a first electronic trading exchange. At time T2, electronic trades for a second leg or third leg, etc. of an automatic spread are automatically adjusted considering market depth information and second or third electronic trading exchanges. Various other combinations of using market depth information on one or more electronic trading exchanges can also be used.

The automatic price adjustments are determined using the set of pre-determined automatic spread calculations including those illustrated in Tables 12-16.

In on embodiment, the spread lean 142 factor is used to automatically determine a number of instruments required using market depth information to be present at an appropriate price to execute trades for a desired leg of an automatic spread. In one embodiment, the spread lean 142 factor acts as a multiplier on the number of instruments being executed on one leg of the spread using market depth information (e.g., so a spread lean 142 value of 1.5 on a ten instruments one/one spread requires that a back leg be showing fifteen instruments to work the spread).

Rather then automatically pulling an order for a working front leg of an automatic spread when the second leg doesn't have enough market depth at it's best bid (or offer if working the other side), market depth information is automatically examined to determine where there is enough market depth so the spread can be automatically worked.

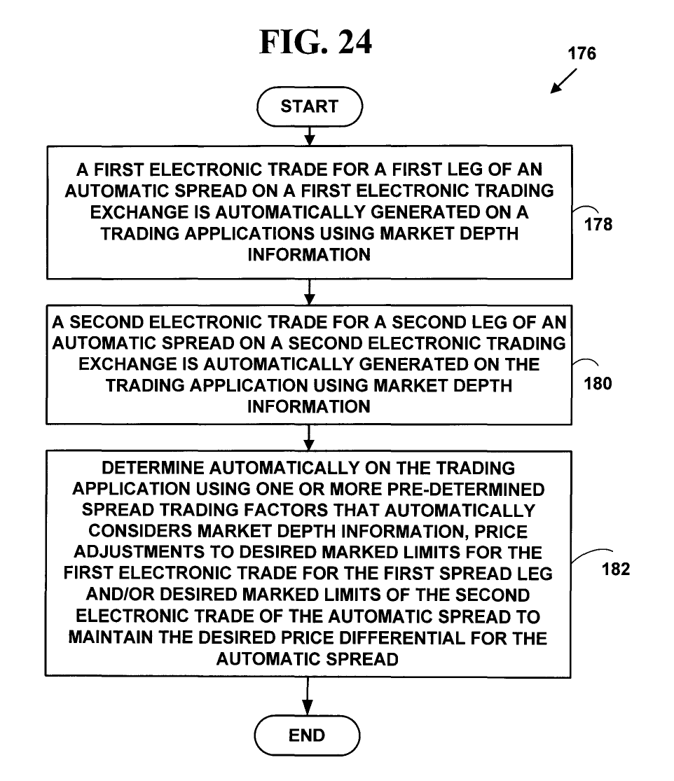

FIG. 24 is a flow diagram illustrating a Method 176 for automatically executing trading spreads. At Step 178, a first electronic trade for a first leg of an automatic spread on a first electronic trading exchange is automatically generated on a trading applications using market depth information. At Step 180, a second electronic trade for a second leg of an automatic spread on a second electronic trading exchange is automatically generated on a trading application using market depth information. At Step 182, price adjustments to desired marked limits for the first electronic trade for the first spread leg, and/or desired marked limits of the second electronic trade of the automatic spread are determined automatically on the trading application using one or more pre-determined spread trading factors that automatically considers market depth information to maintain the desired price differential for the automatic spread.

Method 176 is illustrated with an exemplary embodiment. However, the invention is not limited to this embodiment and other embodiments can also be used to practice the invention.

At Step 178, a first electronic trade for a first leg of an automatic spread on a first electronic trading exchange is automatically generated on a trading application 30 using market depth information.

At Step 180, a second electronic trade for a second leg of an automatic spread on a second electronic trading exchange is automatically generated on a trading application 30 using market depth information.

At Step 182, price adjustments to desired marked limits for the first electronic trade for the first spread leg, and/or desired marked limits of the second electronic trade of the automatic spread are determined automatically on the trading application 30 using the spread lean 142 factor that automatically considers market depth information to maintain the desired price differential for the automatic spread

In one embodiment, Step 182 is executed using the spread lean 142 factor. However, the present invention is not limited to this embodiment, and more or other pre-determined spread factors can also be used to practice the invention.

Method 176 has been described for only two trading orders. However, the present invention is not limited to two spread legs and two trading orders and more than two trading legs and more than two trading orders can also be used to practice the invention. The trading orders can be place for real as well as synthetic trading entities.

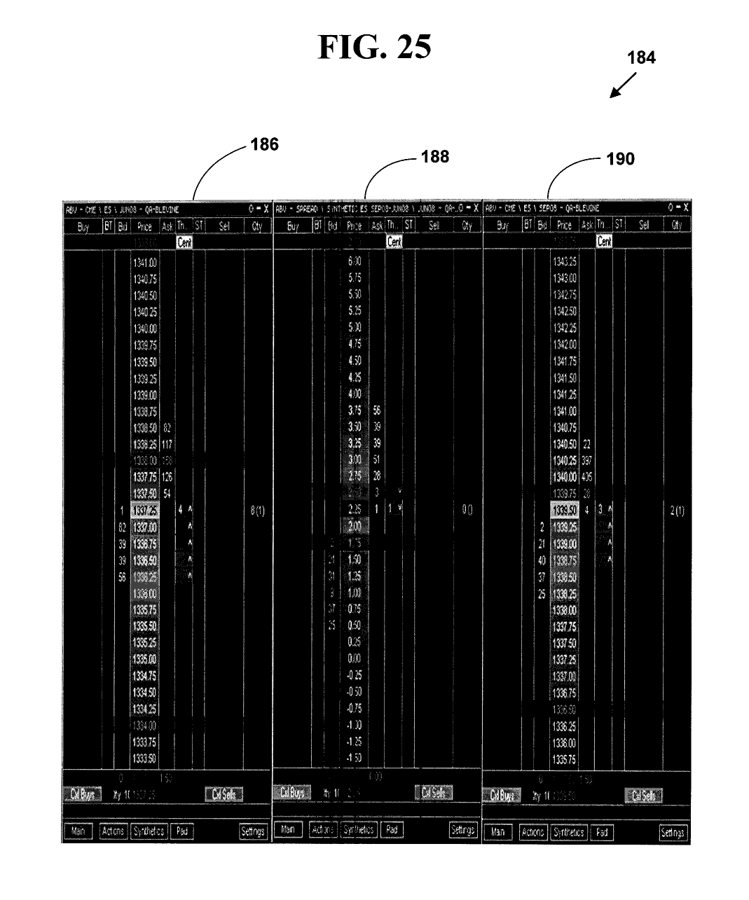

FIG. 25 is a block diagram 184 illustrating exemplary ABV windows 186, 188, 190, illustrating exemplary spread lean 142 factors for an exemplary automatic spread. Graphical ABV windows 186 and 190 illustrate real trading instruments. Graphical ABV window 188 illustrates synthetic trading instruments. FIG. 25 illustrates additional details for Methods 124, 166 and 176 considering the examples in the following paragraphs.

Graphical ABV window 186 illustrates an actual Chicago Mercantile Exchange (CME) E-Mini S&P 500 contract “ES Jun08”. Graphical ABV window 188 illustrates an automatic synthetic spread for an actual CME-E-Mini S&P 500 September 2008—contract actual CME-E-Mini S&P 500 September 2008 contract/actual CME-E-Mini S&P 500 June 2008 contract. Graphical ABV window 190 illustrates an actual CME-E-Mini S&P 500 September 2008 “Sep08” contract.

With a spread lean 142 value of zero, working a twenty instrument sell of a spread at 2.25 in ABV window 186 a sell order at a price of 1339.50 for a Chicago Mercantile Exchange (CME) E-Mini S&P 500 contract “ES Sep08” in ABV window 188 will be executed by the spreader functionality in application 30.

With a spread lean 142 value of one, working a twenty instrument sell of the spread at 2.25, the spreader functionality in application 30 will look at the second leg, and determine that there isn't enough market depth at 1337.25 to get twenty instruments. Based on this determination, the spreader functionality in application 30 will then look and see how far into the market depth it has to go to get twenty instruments (in this example one tick in to 1337.00). The spreader functionality in application 30 adjusts the price of the first leg by 1 tick (to 1339.75 in window 190) to account for the tick it believes it will need to move the second leg of the automatic spread.

With a spread lean 142 value of five, working a twenty instrument sell of the spread at 2.25, in ABV window 188 the spreader functionality in application 30 will look at the second leg, and determine that there isn't enough market depth at 1337.25 to get twenty instruments in ABV window 186. Based on this determination, the spreader functionality in application 30 will determine how far into the market depth it has to go to get twenty instruments (in this example two ticks to 1336.75). The spreader functionality in the application 30 adjusts the price of the first leg of the spread by two ticks (to 1340.00 in ABV window 186) to account for a tick it believes it will need to move the second leg of the automatic spread.

Rather then remove a trading order from a market if a spread lean 142 isn't met, or move a trading order to a price where a total aggregate market depth of is that of a second leg or back leg, trading orders for a first leg or working leg of the automatic spread are lowered to a quantity that matches an available market depth. For example, for a five instrument spread with a spread lean 142 of one, and there were only three instruments available in the back leg at a desired price, a three instrument order would be worked in the automatic spread. If a quantity of instruments available in market depth in the back leg went up to ten, an order would be automatically moved to five instruments in the automatic spread. If a market depth goes down to two instruments, the automatic spread would be automatically moved to two working instruments.

Rather then remove a trading order from the market if a spread lean 142 isn't met, or move the order to a price where the total aggregate market depth of the second leg or back leg, the working leg of the automatic spread is lowered to a quantity that matches the available market depth. The rest of the working quantity of the automatic spread is worked against the available market depth on the best bid/offer out into the trading book. So in the above example where there is only three instruments are available for a five instrument spread, the first three instruments would be worked against the best bid/offer. The remaining instruments would be entered against the second best bid/offer, etc. The instruments in the automatic spread can also broken down further into more working orders depending on the market depth available in a selected electronic trading market. The spreader functionality in the application 30 can also move the entire order, so the order is split up into smaller fractions to fit the available market depth in each desired market.

Rather then remove a trading order from a market if a spread lean 142 isn't met, and rather then brake down or split an order into multiple orders and work them each at a price where an opposite side is available, a size of the working order leg is instead reduced to match an available market depth.

The methods described herein have been described with reference to automatic spreads with two distinct trading legs. However, the present invention is not limited to two distinct trading legs and automatic spreads with more than two distinct trading legs can also be used to practice the invention.

The method and system allow spreads to be automatically inputted, executed and monitored on one or more trading exchanges. The method and system also allows inputting and monitoring of the spreads from one or more graphical windows on a graphical user interface. The method and system provide automatic generation of one or more legs of an automatic spread and automatic readjustment of a desired market limit prices to maintain the desired price differential for the automatic spread. The method and system also use market depth information to automatically adjust desired marked limits for the electronic trades for one or more legs of the automatic spread are determined automatically using a pre-determined spread factor using market depth information on the trading application to maintain the desired price differential for the automatic spread.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams and in other orders.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended.

Therefore, all embodiments that come within the scope and spirit of the following claims and equivalents thereto are claimed as the invention.

We claim:

1. A method for automatically executing trading spreads, comprising:
placing a first trading order for a first leg of an automatic spread on a first electronic trading exchange via a trading application on target device via a communications network, wherein the first trading order includes a first desired market limit price;
automatically readjusting on the trading application the first desired market limit price of the first trading order on the first trading exchange to represent changes in a second desired market price of a second trading order on a second electronic trading exchange to maintain a desired price differential for the automatic spread using pre-determined automatic spread calculations;
receiving a confirmation for fulfillment of the first trading order from the first electronic trading exchange on the trading application;
automatically generating the second trading order via the trading application for a price that satisfies the desired price differential between the first desired market limit price and the second desired market limit price for the second trading order, wherein the second trading order is generated automatically using a pre-determined spread trading factor that automatically considers market depth information on a second electronic trading exchange and the first trading exchange; and
automatically placing the second trading order on the second electronic trading exchange, wherein the second trading order includes the second desired market limit price.

2. The method of claim 1 further comprising a computer readable medium having stored therein a plurality of instructions for causing one or more processors to execute the steps of the method.

3. The method of claim 1 further comprising:
viewing the automatic spread via an Ask Bid Volume (ABV) graphical window on graphical user interface with a plurality of graphical windows generated by the trading application, wherein the ABV window displays a market depth for electronic trades being executed for the automatic spread.

4. The method of claim 1 further comprising:
assigning a unique display color to a plurality of components comprising the automatic spread;
displaying the same assigned unique color for plurality of components of the automatic spread in a plurality of different graphical windows on a graphical user interface, wherein each of the plurality of components of the automatic spread can be easily recognized by the assigned unique color in the plurality of different graphical windows.

5. The method of claim 1 wherein the pre-determined spread trading factor includes a spread lean factor.

6. The method of claim 1 wherein the spread lean factor is a multiplier for a number of instruments bid and/or offered for one or more instruments for a trading order in one leg of the automatic spread to be maintained in another leg of the automatic spread determined using market depth information.

7. The method of claim 1 wherein the pre-determined automatic spread calculations include automatic spread calculations complete using a spread lean factor, spread slippage factor, spread side factor, spread price factor and spread quantity factor.

8. The method of claim 7 wherein the spread slippage factor includes a number of trading price ticks to be added or subtracted to the second trading order to help ensure execution of the second trading order on the second trading exchange, the spread side factor includes and indication of which leg is to be bought when the automatic spread is bought, the spread price includes a desired automatic spread price differential and the spread quantity factor includes a number of instruments for the automatic spread.

10. The method of claim 1 wherein the step of automatically readjusting the price of the first desired market limit price includes automatically readjusting the price using automatic ask and bid price and quantity calculations to maintain the desired price differential for the automatic spread.

11. The method of claim 1 wherein the first trading order includes a set of a plurality first trading orders and the second trading order includes a set of plurality of second trading orders for real or synthetic trading instruments.

12. The method of claim 1 further comprising:
entering desired automatic spread factors used for the pre-determined spread calculations via a graphical automatic spread definition window on the graphical user interface,
wherein the graphical automatic spread definition window accepts inputs for desired automatic spread factors including a spread name, a spread lean factor, a spread slippage factor, a spread instrument factor, a spread side factor, spread price factor and spread quantity factor.

13. The method of claim 1 wherein a graphical contracts windows displays information about the automatic spread on the graphical user interface.

14. A method for automatically executing trading spreads, comprising:
receiving a plurality of automatic spread factors via graphical window on a graphical user interface with a plurality of graphical windows via a trading application on target device via a communications network to execute an automatic spread with a desired price differential for a plurality of trading entities traded the automatic spread;
automatically generating one or more electronic trade orders for one or more legs of the automatic spread on one more electronic trading exchanges via the trading application using a set of pre-determined automatic spread calculations;
receiving a confirmation fulfillment of the one or more electronic trade orders on one or more electronic trading exchanges for one or more legs of the electronic spread on the trading application; and
receiving automatically price adjustments to desired market limits for the electronic trade orders for one or more legs of the automatic spread on the trading application to maintain the desired price differential for the automatic spread, wherein the automatic price adjustments are determined using a pre-determined spread trading factor that automatically considers market depth information and wherein market depth information is automatically considered for the one or more legs of the automatic spread on the one or more electronic trading exchanges to adjust prices to the desired market limits for the electronic trade orders.

15. The method of claim 14 further comprising a computer readable medium having stored therein a plurality of instructions for causing one or more processors to execute the steps of the method.

16. The method of claim 14 further comprising:
displaying the automatic spread via an Ask Bid Volume (ABV) graphical window on graphical user interface with a plurality of graphical windows generated by the trading application, wherein the ABV window displays a market depth for electronic trades being executed affecting the automatic spread.

17. The method of claim 14 wherein the set of pre-determined automatic spread calculations include a first set of automatic calculations using a spread lean factor, spread slippage factor, spread side factor, spread price factor and spread quantity factor and a second set of calculations using ask and bid price and quantity calculations.

18. The method of claim 14 wherein the spread lean factor is a multiplier for a number of instruments bid and/or offered for one or more instruments for an electronic trade order in the one or more legs of the automatic spread to be maintained for other one or more legs of the automatic spread determined using market depth information.

19. A method for automatically executing trading spreads, comprising:
automatically generating on a trading application a first electronic trade for a first leg of an automatic spread on a first electronic trading exchange using market depth information;
automatically generating on the trading application a second electronic trade for a second leg of an automatic spread on a second electronic trading exchange using market depth information;
determining automatically on the trading application using a pre-determined spread trading factor that automatically considers market depth information, price adjustments to desired marked limits for the first electronic trade for the first spread leg and/or desired marked limits of the second electronic trade for the second spread leg of the automatic spread to maintain the desired price differential for the automatic spread.

20. The method of claim 19 further comprising a computer readable medium having stored therein a plurality of instructions for causing one or more processors to execute the steps of the method.

21. The method of claim 19 wherein the pre-determined spread trading factor is a spread lean factor wherein the spread lean factor a multiplier for a number of instruments bid and/or offered for one or more instruments for the first electronic trade in of the automatic spread to be maintained for the second electronic trade of the automatic spread determined using market depth information

22. A system for automatically executing trading spreads on a computer readable medium having stored therein a plurality of instructions for causing one more processors to execute the means for the system, comprising in combination:
means for entering a plurality of automatic spread factors via graphical window on a graphical user interface with a plurality of graphical windows via a trading application on target device via a communications network to execute an automatic spread with a desired price differential for a plurality of trading entities traded the automatic spread;
means for automatically generating one or more electronic trades for one or more legs of the automatic spread on one more electronic trading exchanges via the trading applications using a set of pre-determined automatic spread calculations;
means for automatically making price adjustments to desired marked limits for the electronic trades for one or more legs of the automatic spread on the trading application to maintain the desired price differential for the automatic spread, wherein the automatic price adjustments are determined using the set of pre-determined automatic spread calculations; and
means for determining automatically using a pre-determined spread factor that uses market depth information for making price adjustments to desired marked limits for the electronic trades one or more legs of the automatic spread on the trading application to maintain the desired price differential for the automatic spread.

23. The system of claim 22 further comprising:
means for displaying the automatic spread via an Ask Bid Volume (ABV) graphical window on graphical user interface with a plurality of graphical windows generated by the trading application, wherein the ABV window displays a market depth for electronic trades being executed affecting the automatic spread.
